(19) United States
(12) Patent Application Publication
(10) Pub. No.: US 2026/0164414 A1
(43) Pub. Date: Jun. 11, 2026

(54) NTN-IoT TDD Timings

(71) Applicant: Fraunhofer-Gesellschaft zur Förderung der angewandten Forschung e.V., München (DE)

(72) Inventors: Thomas WIRTH, Berlin (DE); Lars THIELE, Berlin (DE); Thomas HAUSTEIN, Berlin (DE); Chaitali PAWASE, Berlin (DE); Priyanka DEY, Berlin (DE)

(21) Appl. No.: 19/413,233

(22) Filed: Dec. 9, 2025

(30) Foreign Application Priority Data
Dec. 10, 2024 (EP) 24218889.4

(51) Int. Cl. H04W 72/0446; H04L 5/14; H04L 27/26; H04W 56/00; H04W 72/51

(52) U.S. Cl. CPC H04W 72/0446; H04L 5/1469; H04L 27/2605; H04W 56/0015; H04W 72/51

(57) ABSTRACT

Disclosed is a wireless communication device, e.g., a user device, configured for processing a signal transmitted occupying at least one slot/subframe/radioframe that is according to a second wireless communication scheme. The signal is an adaptation of a first communication scheme to fit the second communication scheme.

### CROSS-REFERENCE TO RELATED APPLICATIONS

This application claims priority from German/European Patent Application No. 24218889.4, which was filed on Dec. 10, 2024, and is incorporated herein in its entirety by reference.

Embodiments of the present application relate to the field of wireless communication, and more specifically, to enhancing wireless communication in the field of wireless communication networks, in particular in the field of the internet of things, IOT and more particularly related to the enhancement thereof by using non-terrestrial networks, NTN.

### BACKGROUND OF THE INVENTION

FIG. 1 is a schematic representation of an example of a terrestrial and/or non-terrestrial wireless network 100 including, as is shown in FIG. 1(a), a core network 102 and one or more radio access networks RAN₁, RAN₂, . . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/LTE-A Pro, or just a BS in other mobile communication standards, e.g., 6G. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB4 or for transmitting data from the base stations gNB₂, gNB₄ to the users UE₁, UE₂, UE₃.

Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 1121. The IoT device 110₂ accesses the wireless communication system via the user UEs as is schematically represented by arrow 112₂.

The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may connected, e.g., via the S1 or X2 interface or the Xn interface in NR, with each other via respective backhaul links 116₁ to 1165, which are schematically represented in FIG. 1(b) by the arrows pointing to “gNBs”. Embodiments described herein are not limited to terrestrial networks, TNs, but relate also to networks being implemented, at least in parts, as non-terrestrial network, NTN, as shown in FIG. 1 with reference to a satellite S₁ that may operate, for example, to bridge communication between different base stations, to serve one or more UE and/or a cell on the ground, e.g., as a non-terrestrial base station, to communicate with a different satellite.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard or a 6G standard.

The wireless network or communication system 100 depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above-described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

Therefore, the device described in this disclosure may be a UE, wherein the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, a reduce capability device, RedCap, machine type communication UE, MTC-UE, mobile termination of an IAB-node, MT-IAB, a relay, a relay UE, a remote UE, a terrestrial UE, a non-terrestrial UE, NTN-UE, e.g., a plane, a high-altitude platform, a drone, or a spectrum controller, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, station (STA), access point (AP), node or mesh node, or mesh point, or Mesh AP, or any sidelink capable network entity.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

In an in-coverage scenario in which two UEs directly communicating with each other are both connected to a base station, the base station gNB has a coverage area which, basically, corresponds to the cell schematically represented in FIG. 1. The UEs directly communicating with each other may be both in the coverage area of the base station gNB. Both UEs are possibly connected to the base station, e.g., a gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

In an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. UEs may directly communicate with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the out-of-coverage scenario does not necessarily mean that the respective mode 2 UEs (in NR) or mode 4 UEs (in LTE) are outside of the coverage of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area, in addition to the NR mode 1 or LTE mode 3 UEs also NR mode 2 or LTE mode 4 UEs are present.

Naturally, it is also possible that one of the UEs is covered by the gNB, i.e. connected with Uu to the gNB, wherein the second UE is not covered by the gNB and only connected via the PC5 interface to the first UE, or that the second vehicle is connected via the PC5 interface to the first vehicle UE but via Uu to another gNB.

With an increase of an amount of communication and with an increase of requirements, flexibility of communication is an important issue for wireless communication allowing to adapt to specific needs and to increase an overall efficiency.

There is, thus, a need to improve wireless communications.

### SUMMARY

An embodiment may have a wireless communication device, e.g., a user device, configured for processing [TX/RX] a signal transmitted occupying at least one slot/subframe/radioframe that is according to a second wireless communication scheme; wherein the signal is an adaptation of a first communication scheme to fit the second communication scheme.

Another embodiment may have a wireless communication device configured for operating according to a wireless communication scheme/standard defining a first frame structure including a plurality of slots having a slot structure; receiving a signal indicating to use the slot structure in a second frame structure of a different communication scheme/standard; and to operate accordingly.

Another embodiment may have a user device of a wireless communication system, wherein the user device is to receive a control message containing information on a frame structure of a different wireless communication system, e.g., a different radio access technology, RAT, wherein the user device is to receive a control message or may be configured or pre-configured with an information containing at least one or more of
information on the frame and slot numbers to be used for DL based on the first communication scheme frame structure, e.g., which slots within the first communication scheme frame is used for DL;
information on the frame and slot numbers to be used for UL based on the first communication scheme frame structure, e.g., which slots within the first communication scheme frame is used for UL;
Information on the timing gap being between the start/end of DL active time duration to the start/end of UL active time duration or vice versa.
Information on a timing gap between DL and UL active duration in terms of one or more of the following.

Another embodiment may have a wireless communication device, e.g., a base station, adapted for providing a control message containing at least one or more of
information on a frame structure of a different wireless communication system, e.g., a radio access technology, RAT, different from the WCS
information on a frame structure and slot/subframe numbers to be used for DL based on a frame structure of the first communication scheme, e.g., which slots within the first communication scheme frame is used for DL;
information on a frame structure and slot/subframe numbers to be used for UL based on a frame structure of the first communication scheme, e.g., which slots within the first communication scheme frame is used for UL;
information on a frame structure and slot/subframe numbers to be used for DL based on a frame structure of the second communication scheme, e.g., which slots within the second communication scheme frame is used for DL;
information on a frame structure and slot/subframe numbers to be used for UL based on a frame structure of the second communication scheme, e.g., which slots within the second communication scheme frame is used for UL;
Information on a timing gap being between the start/end of DL active time duration to the start/end of UL active time duration or vice versa;
Information on a timing gap between DL and UL active duration in terms of one or more of the following:
Information on a timing gap being between the start/end of DL active time duration to the start/end of a next DL active time duration or vice versa;
Information on a timing gap being between the start/end of UL active time duration to the start/end of a next UL active time duration or vice versa;
Information on an absolute or relative position of one or more received sequences for time or frequency synchronization within a frame, super frame structure or other repeated/reoccurring time structure;
Information on further absolute or relative position of one or more sequences for time or frequency synchronization within a frame, super frame structure or other repeated/reoccurring time structure which can be received in future;
Information on absolute or relative position of one or more sequences for time or frequency synchronization within a frame, super frame structure or other repeated/reoccurring time structure and there scheduled repositioning.

It is noted that the information in the above section is only for enhancing the understanding of the background of the invention and therefore it may contain information that does not form conventional technology and is already known to a person of ordinary skill in the art.

### BRIEF DESCRIPTION OF THE DRAWINGS

Embodiments of the present invention will be detailed subsequently referring to the appended drawings, in which:

FIG. 1(a) shows a core network 102 and one or more radio access networks RAN₁, RAN₂, . . . . RAN_{N};

FIG. 1(b) is a schematic representation of an example of a radio access network RANₙ;

FIG. 2 is a schematic representation of a wireless communication system comprising a transceiver, like a base station or a relay, and a plurality of communication devices, like UEs, according to an embodiment;

FIG. 3a shows a schematic representation of a LTE radio frame;

FIG. 3b shows a schematic representation of a LTE TDD frame structure, denoted as type 2;

FIG. 3c shows a schematic representation of a structure if a narrowband IoT, NB-IoT frame in connection with embodiments;

FIG. 4 shows a schematic table representing allowed TDD radio frame structures in LTE;

FIG. 5 shows a table taken from 3GPP TS 38.300 showing 5G-NR supported transmission numerologies;

FIG. 6 shows a diagram to illustrate the concept of Timing Advance, TA, in connection with embodiments described herein;

FIG. 7 shows a schematic representation of IoT LTE frequency bands as described in TS 36.108/TS 36.102

FIG. 8a-c show schematic diagrams of a fundamental unit of the TDMA channel being a time-slot which is organized into frames;

FIG. 9 shows a schematic block diagram of a wireless communications network according to an embodiment;

FIG. 10a shows schematic representations of options to fit an 8 ms LTE radioframe into an 8.28 ms IRIDIUM slot structure, according to embodiments;

FIG. 10b shows a frame structure type 1 used for IoT NTN TDD according to an embodiment;

FIG. 11 shows a schematic representation related to selecting one or more IRIDIUM slots for LTE NB-IOT transmissions; according to an embodiment;

FIG. 12 shows schematic representations of options to fit two 8 ms LTE radioframes into more than one 8.28 ms IRIDIUM slot structure, according to embodiments;

FIG. 13 shows a schematic representation of a mapping to handle a gap between the DL and UL active time durations according to an embodiment;

FIG. 14 shows a schematic diagram relating to a gap between the DL and UL active time duration being in terms of an integer multiple of subframes, according to an embodiment;

FIG. 15 shows a schematic diagram relating to a gap resulting from separate LTE frame/subframe counters being maintained for UL and DL, according to an embodiment;

FIG. 16a-d show schematic diagrams illustrating several possibilities for implementing a frequency hopping in connection with embodiments; and

FIG. 17 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals or namings even if occurring in different figures.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

In connection with embodiments described therein, the term slot as well as the term subframe is used. Furthermore, terms like frame and radioframe are used. Although the respective term may indicate a system in which the feature is implemented, the terms are also used as synonyms in embodiments described therein. A reason is that a slot may refer to networks such as terrestrial networks, 4G-LTE and 5G-NR respectively. These operate on a frame structure with slots. On the other hand, an LTE radioframe may comprise or consist of ten subframes. Embodiments relate to match one schedule to another and in view of such a matching, it may be of less importance from which side of the matched system the terminology origins from. Thus, if a UE adapts its communication associated with, e.g., slots or subframes, there is a schedule associated with subframes, slots respectively, then the overall communication is still provided in accordance with the configuration of the UE. For example, embodiments relate to having a UE that is implemented to provide for NB-IOT slots of a respective duration of 1 milliseconds. To fit a different timing schedule, e.g., a radioframe having a duration of 90 milliseconds, having several slots (in some embodiments, the example of 8.28 milliseconds is given), the device may reduce the number of slots and/or subframes to be transmitted whilst maintaining the respective duration of 1 milliseconds per slot. In some examples given, the number is reduced to an amount of 8 to fit into the slot of the other system and, considered as a whole, it is of less importance whether to refer to a slot or a subframe to describe such a behavior. Therefore, the terms slot and subframe and possibly radioframe may be used as synonyms in connection with embodiments described herein.

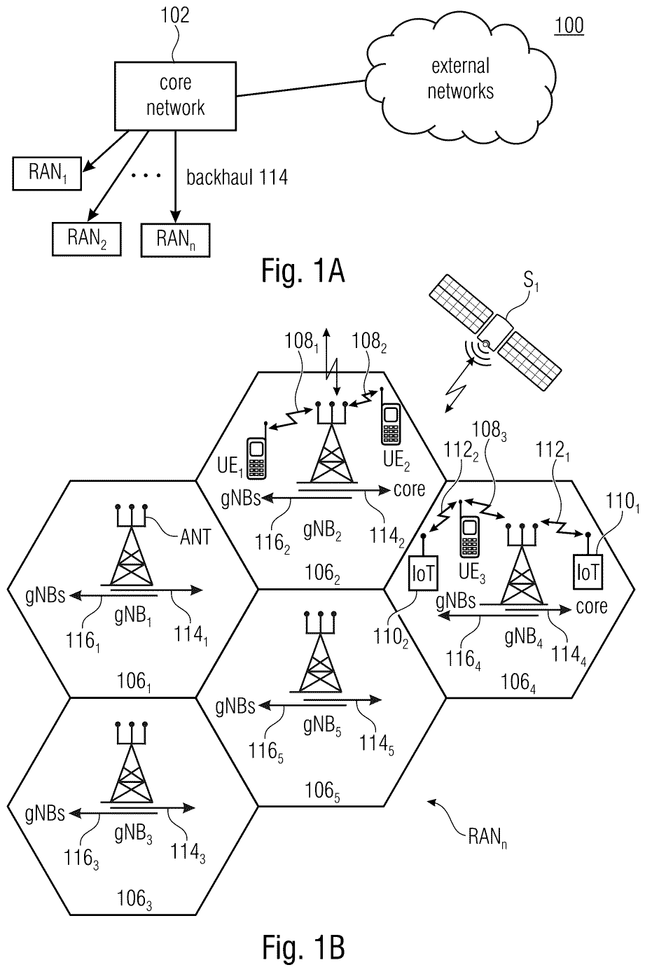

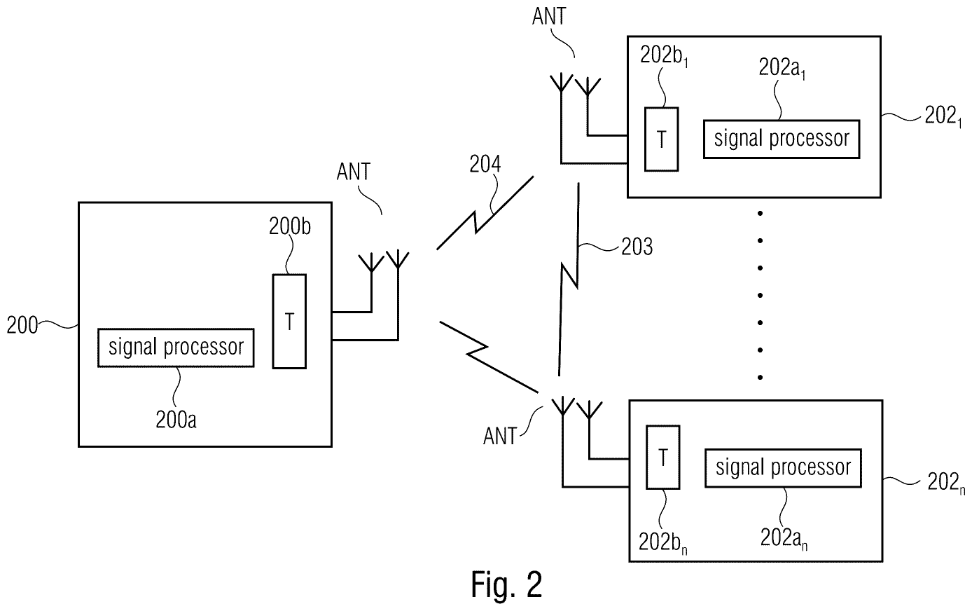

Embodiments of the present invention may be implemented in a wireless communication system or network as depicted in FIG. 1 including a transceiver, like a base station, gNB, or relay, and a plurality of communication devices, like user equipment's, UEs. FIG. 2 is a schematic representation of a wireless communication system comprising a transceiver 200, like a base station or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the Uu interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a₁ to 202aₙ, and a transceiver (e.g., receiver and/or transmitter) unit 202b₁ to 202bₙ. The base station 200 and/or the one or more UEs 202 may operate in accordance with the inventive teachings described herein. Note, that a physical resource block, PRB, related to the actual transmitted signal, which may be located relative to a reference point A on a given resource grid. For this, the reference point A coincides with subcarrier 0 of common resource block, CRB, 0 for all subcarrier spacings. The resource grid may consist of a number of subcarriers, e.g., 12 subcarriers in frequency domain, and a number of OFDM symbols in time domain. In general, a PRB is defined by a start subcarrier, a number of subcarriers, and a subcarrier spacing, defined by the numerology. The numerology sets the subcarrier spacing and is defined per bandwidth part, BWP. The resource blocks are aligned across numerologies, such that two resource blocks at a subcarrier spacing s, occupy the same frequency range as one resource block at a subcarrier spacing of 2s. Furthermore, we may use resource block and physical resource block interchangeably. Finally, also the term virtual resource block, VRB, may be used, which contain the modulation symbols that are mapped to the PRBs in the bandwidth parts used for transmission. Note that VRBs may be mapped interleaved or non-interleaved to the PRBs, depending on the configuration.

A recognition of the present invention is that a signal may be processed not only when being transmitted in accordance with a respective wireless communication scheme implemented in a network. As a wireless communication scheme one may understand an implementation, e.g., using code division multiple access, CDMA, time division duplex, TDD, frequency division duplex, FDD/FDM, spatial multiplexing, duplexing schemes such as subband for duplex, SBFD, along with an organization of the respective resources. For example, a number and/or a duration of slots within a frame implemented in the wireless communication scheme may form a part of the wireless communication scheme. Different wireless communication schemes may, thus, differ in view of a number of slots, e.g., provided within a frame, a gap, e.g., in the time domain or in the frequency domain, in the spatial domain or in the code domain, the gap located between two slots within the same frame or, e.g., between slots of different frames such as a last slot of a frame and the first slot of a subsequent frame. Different communication schemes may differ in view of the use synchronization structure and/or in view of an offset or shift of one or more slots within a same or within different frames.

The wireless communication schemes may thus differ in one or more of a duration and a timing of a radioframe and/or in view of a slot structure. One of the wireless communication schemes, the first or the second may be, for example, an NB-IOT standard whilst the other may differ threefrom.

The inventors have found that it of advantage to provide for a device such as UE that is adapted to access resources in different ways. Such resources may be operated or may be managed according to different wireless communication schemes and a device in accordance with the present disclose may access those different schemes by adapting a signal to fit the one wireless communication scheme when being set up or generated for the second wireless communication scheme.

This may be applicable, for example, when considering a device such a UE that adapted to communication within different wireless communication networks such as, as non-exclusive examples only, a terrestrial network and a non-terrestrial network. Some NTN communication networks may be operated according to a different wireless communication scheme when compared to the terrestrial communication scheme and/or vice versa.

Different networks, not necessarily differing with regard to TN and NTN networks, may operate according different communication schemes. Thos different schemes may be relevant for a device, e.g., when being in coverage of both networks at same time or at different times. For example, a device may be in coverage of two or more of at least one TN such as an LTE, LTE IoT, 5G/NR network, at least one NTN and/or other networks.

For example, a non-terrestrial network, e.g., comprising satellites or other possibly flying devices carrying base stations or the like, may operate according to a different wireless communication scheme, when compared to a terrestrial network e.g., relating to the frame duration, the number and/or duration of slots or the like. As an advantage relating to operation under consideration of the present disclosure, the device may transmit and/or receive, i.e., process, a signal in either of both communication schemes. By using the signal as an adaptation of a first communication scheme to fit the second communication scheme, for example, the symbol duration, the number of occupied slots, or the like may be adapted to thereby use the second communication scheme with the signal that was generated in view of the first communication scheme.

For example, NB-IOT was introduced in LTE Rel-13. Enhancements were made to support NB-IOT over satellite or non-terrestrial networks, NTN, also referred to as NTN-IoT. Furthermore, NB-IOT supports TDD and FDD frame structures. Iridium Communication System (ICS) operates a constellation of 66 low Earth orbit (LEO) satellites, the ICS having a unique TDMA frame structure.

To improve resource usage, it is found that within the present disclosure, amongst others, NB-IOT may use the ICS. Embodiments provide adaptations to existing systems in order to operate NTN-IoT via the Iridium constellation. These adaptations allow to match the radio frame structure of NB-IOT TDD to the special timings of the Iridium TDMA frame structure.

That is, in general embodiments include operation across different frequency bands for NTN especially but not necessarily Iridium system constellation works at ˜1.6 GHZ (ITU-R Mobile satellite service allocated band worldwide).

### The NB-IOT TDD Frame Structure

According to the NB-IOT TDD frame structure Downlink and uplink transmissions are organized into radio frames with 10 ms duration. Three radio frame structures are supported in known systems:
Type 1, applicable to FDD only;
   Frame structure type 1 is applicable to both full duplex and half duplex FDD only
   Type 2, applicable to TDD only;
   Type 3, applicable to LAA secondary cell operation with normal cyclic prefix only;

For FDD, 10 subframes, 20 slots, or up to 60 subslots are available for downlink transmission and 10 subframes, 20 slots, or up to 60 subslots are available for uplink transmissions in each 10 ms interval. Uplink and downlink transmissions are separated in the frequency domain. In half-duplex FDD operation, the UE cannot transmit and receive at the same time while there are no such restrictions in full-duplex FDD.

It is noted that example 4G-LTE and 5G-NR operate on a frame structure with slots consisting of (OFDM) symbols. In the described novel setting the system may use a kind of “super frame” consisting of 4G or 5G frames, wherein the number of slots is adapted such that the new frame lengths matches particular periods, e.g. 8.28 ms. Furthermore, to make the overall super frame length match with a given length of, e.g. 90 ms time gaps/guards may be inserted, wherein the positioning of these gaps, there length and their distribution is one of the cores of the present invention.

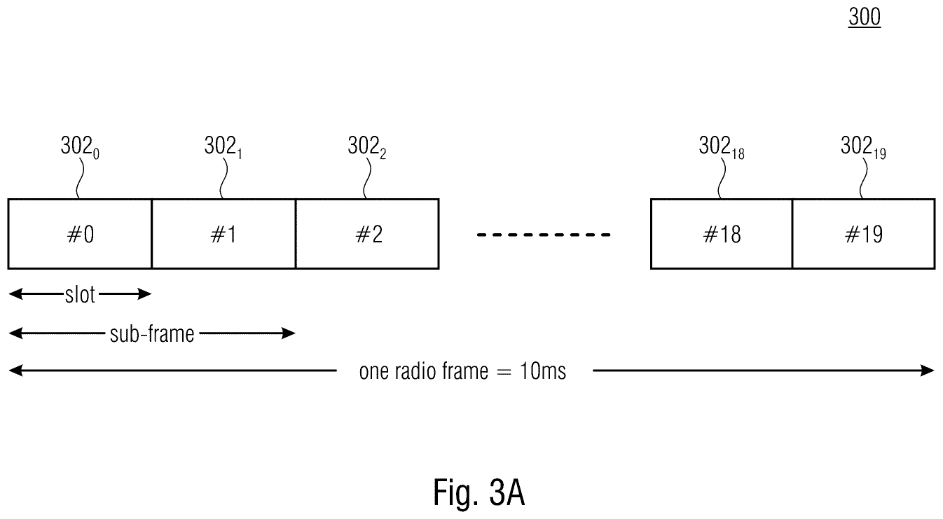

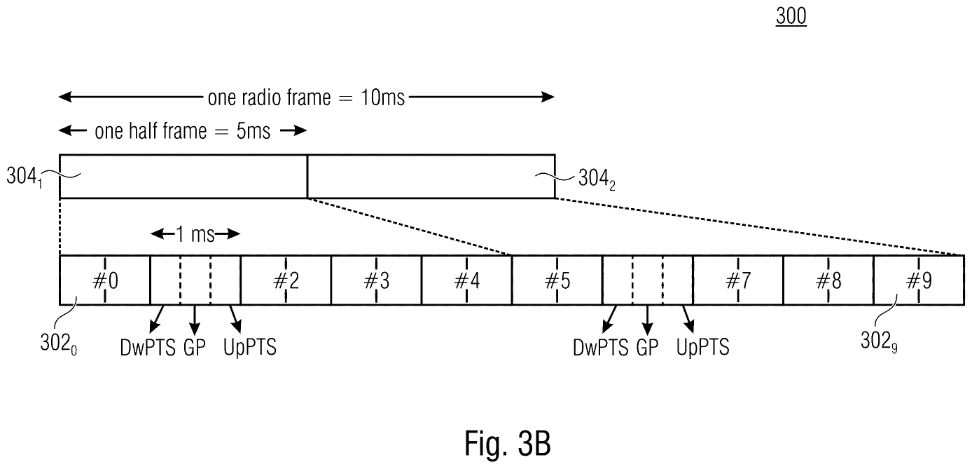

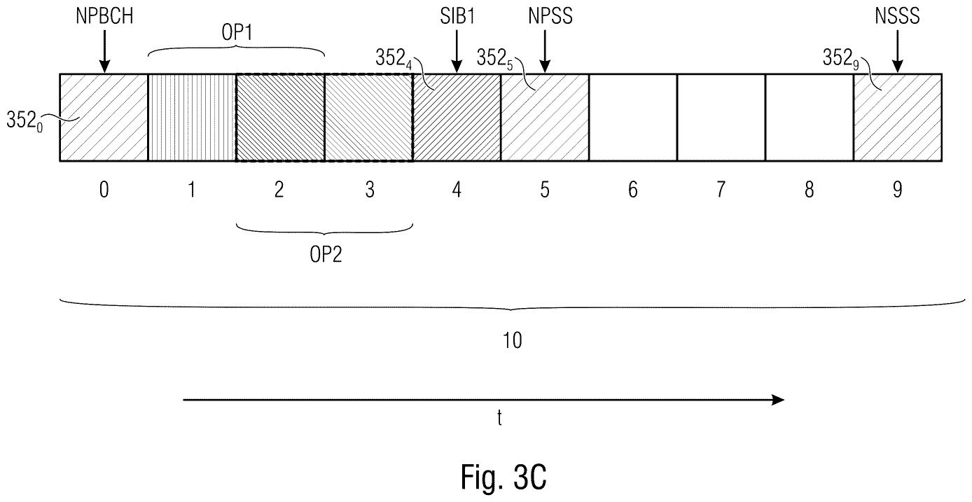

The LTE radio frame structure being also shown in FIG. 3a is defined as follows:
radio frame 300 has a length in time of 10 ms
1 radio frame consists of 10 subframes 302₀ to 302₉
each subframe consists of 2 slots 302
each slot consists of 7 OFDM symbols, using 15 kHz subcarrier spacing and a symbol length of 66.7 μs.

In detail, the LTE TDD frame structure, denoted as type 2, is given as shown in FIG. 3b:

Radio frame 300 comprises 2 half frames 304₁ and 304₂ each of 5 ms length in time. Accordingly, each half frame 304₁ and 304₂ comprises half of the overall 20 slots 302, i.e., 10 slots, e.g., slots 302₀ to 302₉ for half frame 304₁, each slot having 1 ms length in time.

FIG. 3c shows a schematic representation of a structure if a narrowband IoT, NB-IOT frame 350. For example, in a given number of slots, e.g., 10 slots 352₀ to 352₉, some slots may be used over time t for transmitting system data or synchronisation data and others may be used for downlink data. For example, the narrowband physical broadcast channel, NPBCH is carried in slot 0, the SIB, e.g., SIB1, is carried in slot 4, the narrowband primary synchronization signal, NPSS, is carried in slot 5, and the narrowband secondary synchronization signal, NSSS is carried in slot 9. A device according to an embodiment may be adapted to expect downlink data in such slots. Furthermore, some or all of these signals could be optional and/or occupying other slots, e.g., the SIB1 could not be included within a transmission. In addition, slots may be used for data signals. In one embodiment, single slots can be allocated to be used for control and/or data.

According to an embodiment, an amount of slots being used may be subject of different options, e.g., to use 2 or 3 possibly but not necessarily consecutive slots in different options, e.g., option 1 and option 2, not excluding a third option to use slots 1, 2 and 3. That is, more than 1 slot may be used for a larger data packet, e.g., choosing option 1, OP1, when transmitting data in slot 1 and 2, or choosing option 2, OP2, when transmitting data in slots 2 and 3. Furthermore, this does not preclude further options, of slots or aggregated use of slots, which may be concatenated together. Finally, the slot may form a frame or radioframe of 10 units, e.g., 10 slots.

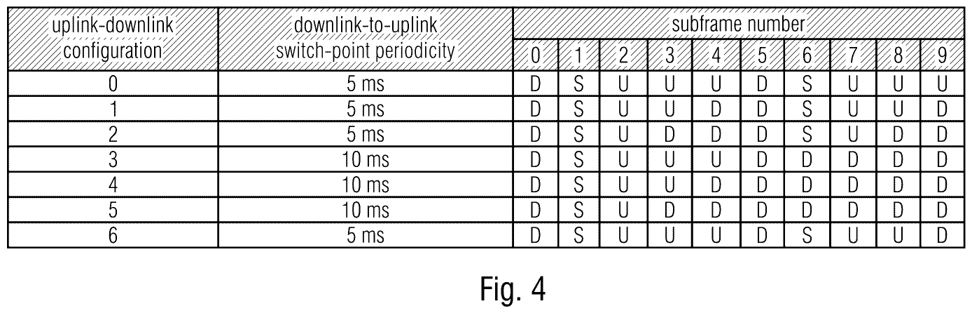

Allowed TDD radio frame structures in LTE is depicted in the table of FIG. 4. Note that a subframe can be marked as
D, corresponding to a downlink subframe,
S, special subframe, contains the downlink and uplink pilot timeslots (DwPTS and UpPTS) separated by a transmission gap guard period (GP), see FIG. 3b. The Guard Period is used as a guard to switch between downlink and uplink and avoid that downlink signals from neighboring base station cause interference when trying to decode uplink signals. Note that in cellular telecommunication this is crucial due to the asymmetry in transmit power between base stations, BS, and user equipments, UEs. BS in cellular systems typically transmit with a much larger transmit power, e.g., 43 dBm, as compared to UEs, which may transmit with only 20-23 dBm or high power UEs which may transmit with up to 26 dBm. Thus, a high-power transmission from a neighboring BS which is not aligned will cause the analog-digital converters, ADCs, to go into saturations, causing the BS to fail decoding a potential uplink signal. Thus, time alignment between BS transmitters is an important design criterion,
U, the uplink subframe.
Subframes 0 and 5, and DwPTS are reserved for DL transmission whereas UpPTS and the subframe immediately following the special subframe are reserved for UL transmission as shown in FIG. 3b and describe in the table of FIG. 4

### NR Numerology

The 5G-NR numerology is based on exponentially scalable sub-carrier spacing for primary synchronization sequency (PSS), secondary synchronization sequency (SSS), and physical broadcast channel (PBCH). 12 consecutive sub-carriers form a Physical Resource Block (PRB). Up to 275 PRBs are supported on a carrier.

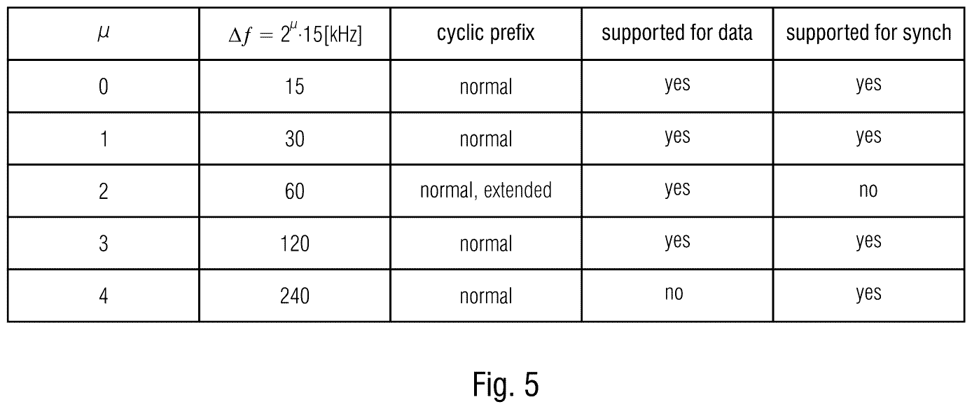

FIG. 5 shows a table taken from 3GPP TS 38.300 showing 5G-NR supported transmission numerologies.

The UE may be configured with one or more bandwidth parts on a given component carrier, of which only one can be active at a time, as described in subclauses 7.8 and 6.10 of 3GPP TS 38.300 respectively. The active bandwidth part defines the UE's operating bandwidth within the cell's operating bandwidth. For initial access, and until the UE's configuration in a cell is received, initial bandwidth part detected from system information is used.

As described above, downlink and uplink transmissions are organized into frames with 10 ms duration, consisting of ten 1 ms subframes. Each frame is divided into two equally-sized half-frames of five subframes each. The slot duration is 14 symbols with Normal cyclic prefix (CP) and 12 symbols with Extended CP, and scales in time as a function of the used sub-carrier spacing so that there is an integer number of slots in a subframe.

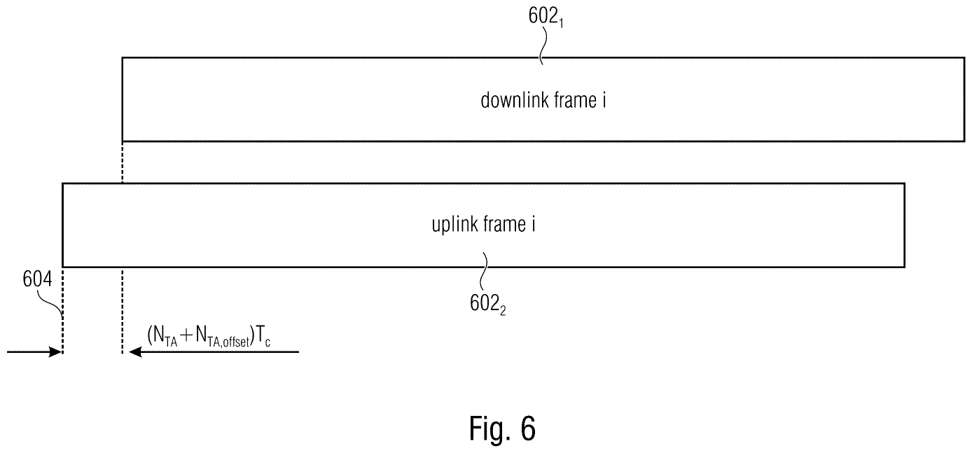

Timing Advance TA is used to adjust the uplink frame timing relative to the downlink frame timing, see FIG. 6 showing an uplink-downlink relationship according to 3GPP TS 38.300. In FIG. 6 an uplink frame 602₂ may be offset in time by the TA 604 with regard as when the frame would have been a downlink frame 602₁, i.e., the device transmits the uplink frame 602₂ earlier to allow a synchronized reception at the receiver, e.g., the gNB. The TA 604 may be determined based on the determination rule

$$TA = ( {N}_{TA} + {N}_{TA , offset} ) {T}_{c}$$

where N_{TA} is a quantized value representing the time adjustment in multiples of T_{c}; N_{TA}, offset is a fixed offset added to the TA to account for the base station's processing time and switching delays, e.g., between uplink and downlink and T_{c} and T_{c} being 1/(Δf_max×N_{f}) seconds, Δf_max being, e.g., 480 KHz and N_{f} being, e.g., 4096.

In 5G NR (New Radio), particularly for Non-Terrestrial Networks (NTN) and IoT, Subcarrier Spacing (SCS) plays a critical role in determining the timing of radio frames, subframes, and slots. Subcarrier Spacing directly impacts the numerology used in the network, which in turn influences the transmission timings, frame duration, and how efficiently the system can handle various challenges, such as propagation delay, especially in NTN environments.

In 5G NR, the choice of Subcarrier Spacing (SCS) significantly impacts the timing of radio frames, which is crucial for NTN-IoT applications. The SCS determines the duration of slots and symbols, directly influencing the system's ability to handle the unique challenges of non-terrestrial networks, such as long propagation delays and Doppler shifts. Lower SCS values (e.g., 15 kHz, 30 kHz) provide longer slot durations, making them more resilient to high latency and Doppler effects, which are common in satellite-based systems like those in Geostationary Earth Orbit (GEO) or Medium Earth Orbit (MEO). These lower SCS configurations are ideal for IoT applications that prioritize reliability and power efficiency over low-latency. Conversely, higher SCS values (e.g., 60 kHz, 120 kHz) result in shorter slot durations, which offer faster data transmission but are more sensitive to timing errors, making them better suited for low-latency applications in Low Earth Orbit (LEO) with shorter propagation delays. Thus, selecting the appropriate SCS is key to optimizing the performance of NTN-IoT systems based on the specific deployment scenario and traffic requirements.

### NB-IOT TDD Frame Structure

Narrowband IoT, NB-IOT, is a lightweight frame structure, which was introduced in order to support UEs having a very low power class, and which have a reduced complexity. NB-IOT is based on LTE technology and operates in a very narrowband of only 12 subcarriers which is basically the same as 1 physical resource block, PRB, as used in LTE. With a subcarrier spacing of 15 kHz, this results in a signal occupying only 180 KHz of bandwidth, but being self-contained including broadcast channel, a control and/or a data channel, as well as transmitting a well-defined set of reference signals.

LTE NB-IOT was standardized in LTE Rel-13. Later on, NB-IOT TDD was specified in LTE Rel-17, which only supports a subset of TDD configurations, e.g., uplink-downlink configuration

1-5 in lines μ=0-4, see the table in FIG. 5.

### NTN IOT Enhancements

In the development of NTN-IoT, power consumption and battery life have become critical areas for optimization. One of the significant challenges is ensuring efficient time and frequency synchronization while maintaining long battery life, a key requirement for IoT deployments. In Release-17, several techniques were explored to address power consumption, particularly in GNSS-enabled devices that operate over NB-IOT and eMTC. These enhancements focused on mitigating the energy drain caused by frequent GNSS position fixes and optimizing uplink transmissions.

The studies identified that separate and integrated GNSS and IoT modules exhibit varied power consumption profiles. For instance, devices using an integrated GNSS and IoT module, such as those evaluated by MediaTek and Huawei, consumed less power (around 100 mW) compared to separate module configurations (e.g., CATT's system with 216 mW). In scenarios where GNSS position fixes were needed before every UL transmission, battery life was reduced by as much as 30-40%. By aligning the simulation models, companies demonstrated that under medium coupling loss (MCL=154 dB), battery life ranged between 6 to 16 years, depending on the reporting interval and packet size. Techniques such as hot-start (1-2 seconds) and warm-start (5 seconds) GNSS position fixes were compared, with hot-starts significantly improving the battery performance.

To further enhance NTN-IoT, the following technologies and/or strategies can be utilized:
Timing Relationship Optimization: Enhancements to timing relationships, such as NPDCCH to NPUSCH and HARQ feedback processes, can reduce power consumption by optimizing when UEs monitor PDCCH after a transmission. For instance, reducing the need for continuous PDCCH monitoring can save significant energy in idle modes. Additionally, Time-Division Duplex (TDD) frame structures can be applied to better manage UL/DL switching in the presence of large round trip delays (RTDs) caused by satellite propagation. This frame structure is designed to allocate specific time windows for uplink and downlink transmissions, ensuring that Timing Advance (TA) values compensate for long transmission delays, improving synchronization between the UE and satellite.
Segmented Uplink Pre-compensation: Long UL transmissions need pre-compensation for satellite delay and Doppler shift. Techniques such as segmented pre-compensation, applied over N time units, are being evaluated to reduce phase discontinuities and signal drift during long transmissions. This segmented approach adjusts frequency offsets in blocks, ensuring that signals maintain coherence over extended transmission periods. The integration of TDD frame structures further supports uplink pre-compensation by separating uplink and downlink phases, helping to handle high TA values without impacting synchronization and link quality.
Battery Life Mitigation Techniques: For fixed IoT sensors or applications where the GNSS position is available at the application layer, it was demonstrated that GNSS impact on power consumption is negligible. For mobile UEs, advanced synchronization techniques such as connected-mode DRX and GNSS fixes only for sporadic transmissions can reduce energy consumption by 34% to 45%. In TDD frame structures, the UL/DL switching intervals ensure that UE remains in low-power mode during inactive periods, further extending battery life. By adjusting the frame timing to match the satellite's orbit and the UE's location, power consumption can be efficiently managed during periods of extended inactivity.

For example, a device described herein such as a UE may be configured to optimize power consumption by selectively activating or deactivating subsets of slots as part of the adaptation. Embodiments thus relate to a power efficient slot usage solution in this claim for optimizing power efficiency based on slot usage

These advancements aim to enable NTN IoT devices to operate efficiently in scenarios with long transmission intervals, high satellite delays, and harsh environmental conditions, while preserving the battery life for operation. By leveraging TDD frame structures and optimizing the timing and frequency relationships with proper TA adjustments, NTN IoT systems can achieve enhanced synchronization, power efficiency, and improved battery longevity.

In the context of IoT-NTN, FDD operation presents significant opportunities for enhancing performance and coverage. FDD, which utilizes separate bands for UL and DL transmissions, can improve synchronization and efficiency in satellite-based IoT systems. However, deploying IoT-NTN using FDD needs specific enhancements to address challenges such as long RTDs, Doppler shift, and propagation losses inherent to satellite communication.

Key enhancements for FDD-based IoT-NTN include optimizing timing relationships between UL and DL transmissions. With the large delays associated with satellite links, TA mechanisms have to be refined to account for satellite motion and extended distances, ensuring that devices maintain robust connectivity without excessive power consumption or synchronization errors. Additionally, DL synchronization needs to be improved to manage Doppler shifts caused by satellite movement, particularly in LEO constellations.

Another critical area is resource allocation and bandwidth efficiency in FDD. Efficient spectrum management is essential for maintaining global coverage, and enhancements should focus on optimizing the link budget and power efficiency, particularly for battery-constrained IoT devices. FDD mode allows more reliable and scalable NTN services, especially in scenarios needing continuous and frequent communication, but it also necessitates the development of adaptive coding and modulation schemes to mitigate signal degradation. These enhancements make FDD a vital area of focus for future 3GPP releases like Release 19.
Timing and Frame Structure in IoT-NTN FDD:
   In IoT-NTN FDD, the frame structure is designed to handle the delay from satellite propagation, which can introduce several hundred milliseconds of latency. The timing of UL and DL transmissions is governed by timing advance (TA), which compensates for the signal delay caused by the distance between the satellite and the UE (User Equipment). TA ensures that UL transmissions are adjusted so that they arrive at the satellite at the correct time, despite the propagation delay.
Key timing parameters for IoT-NTN in FDD include:
   Frame Duration: In 3GPP systems like NB-IOT, the frame duration is typically 10 ms, broken into 1 ms subframes.
   UL/DL Subframes: In FDD, UL and DL transmissions occur continuously on separate bands, meaning no switching time is needed between UL and DL. However, timing alignment between these two channels is crucial, especially due to the long propagation delays in NTN.
   TA Value: The TA values have to be significantly larger in NTN compared to terrestrial networks. For LEO satellites, typical RTDs can range from 50 to 100 ms, while for GEO satellites, RTDs can go up to 500 ms or more. The TA have to be dynamically adjusted based on the satellite's position relative to the UE.

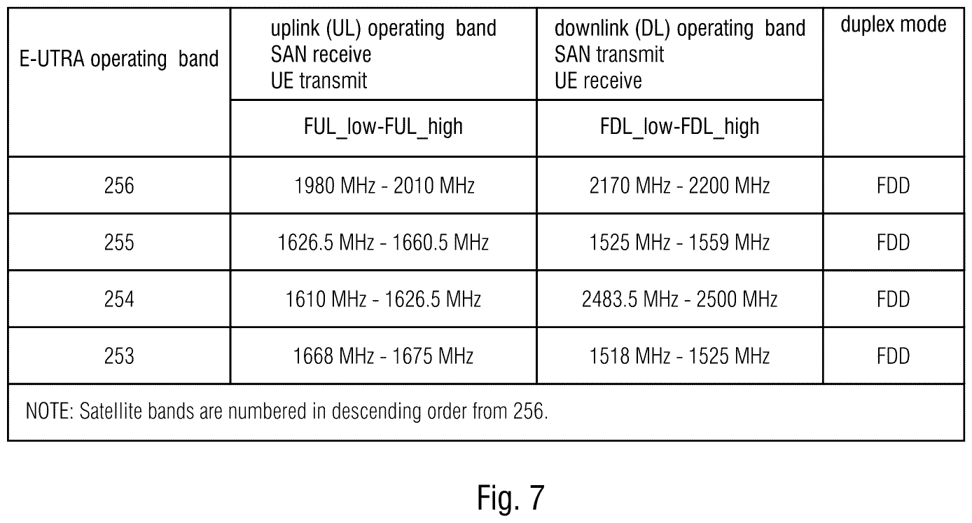

IoT LTE frequency bands are described in TS 36.108/TS 36.102 and illustrated in FIG. 7

In accordance with embodiments, a NB-IOT NTN service can be launched over an existing LEO constellation, providing true global coverage and complementing terrestrial coverage offered by MNOs worldwide. To enable this service, several enhancements are possibly of benefit or even needed. These enhancements may include further improvements for IoT-NTN in duplex mode operation, enhancements in network energy savings, and the definition of a new band for half-duplex operation in unpaired spectrum. Additionally, a new reference scenario, different from those in TR 36.763, may be beneficial or useful or even needed for future normative work. Given the limited enhancements needed and the significant benefits for the IoT-NTN ecosystem, the potential technical solutions are proposed in next section to support NB-IOT operation in TDD mode over NTN system.

### Iridium TDMA Frame Structure

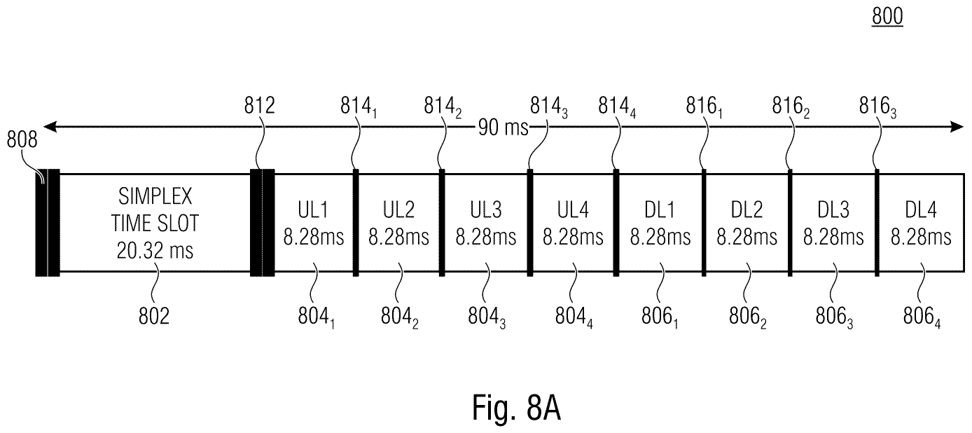

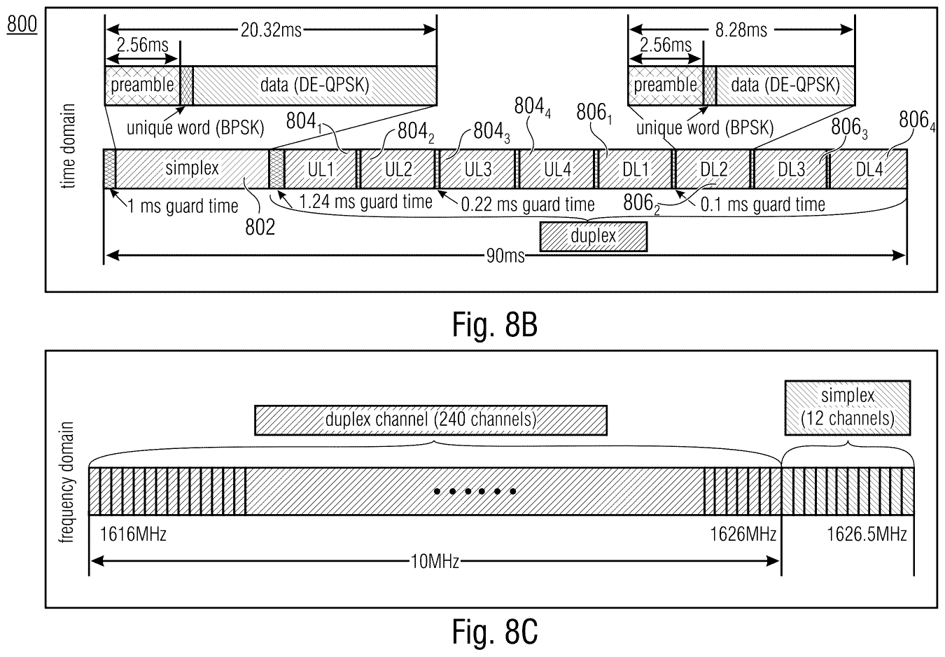

The fundamental unit of the TDMA channel is a time-slot. Time-slots are organized into frames. The L-Band subsystem TDMA frame 800 is illustrated in FIG. 8a-c. The frame consists of a 20.32 millisecond downlink simplex time-slot 802, followed by four 8.28 millisecond uplink time-slots 804₁ to 804₄ and four downlink time-slots 806₁ to 806₄, which provide the duplex channel capability. The TDMA frame also includes various guard times to allow hardware set up and to provide tolerance for uplink channel operations. Furthermore, as depicted in FIG. 8b, the frame may consist of gaps between Simplex slot, uplink slots, UL, and downlink slots, DL. These gaps may have a length of 1 ms, 1.24 ms, 0.22 ms, or 0.1 ms or any combination thereof, adding up to a total gap length of 3.44 ms. The total frame length of 90 ms, includes the synchronization slot, SIMPLEX, as well as all slots used for uplink, UL, and or downlink, DL, as well as all gaps between slots. Note, the gap or guard time between downlink and uplink transmission is thus longer, to compensate transmission with high power, so that a future UL transmission is not disturbed, and which enables TDD UEs to switch between DL reception and UL transmission without interference from a high power base station.

The simplex time-slot supports the downlink-only, ring and messaging channels. The Acquisition, Synchronization, and Traffic channels use the uplink time-slots. The Broadcast, Synchronization, and Traffic channels use the downlink duplex time-slots.

The L-Band frame provides 2250 symbols per frame at the channel burst modulation rate of 25 ksps. A 2400 bps traffic channel uses one uplink and one downlink time-slot each frame.

Additional guard times in the IRIDUM TDMA frame structure are marked below:

| | |
|---|---|
| ┐ 1 ms guard time 808 → | in front of the Simplex time slot |
| ┘ 1.24 ms guard time 812 → | following the Simplex time slot |
| ┐ 0.22 ms guard time 814 → | after each UL slot |
| ┐ 0.1 ms guard time 816 → | between successive DL slots 806₁ to 806₃ |

Note, that and additional time gap of 0.02 ms can be applied as a guard time to any of the guard times defined above, such that the overall frame length sums up to 90 ms.

FIG. 8b shows a schematic representation of the L-Band subsystem TDMA frame 800 according to FIG. 8a in the time domain and FIG. 8c shows a schematic representation of the L-Band subsystem in the frequency domain.

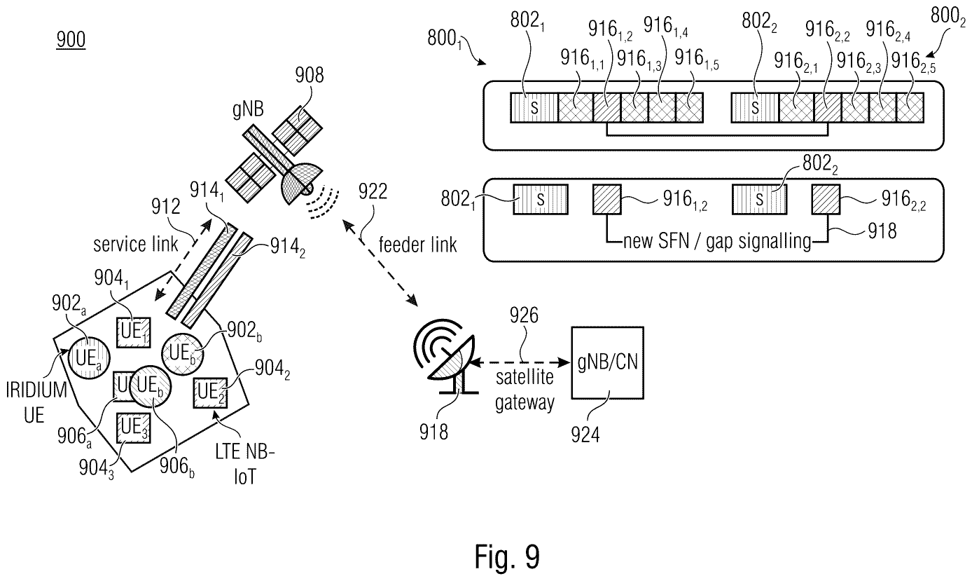

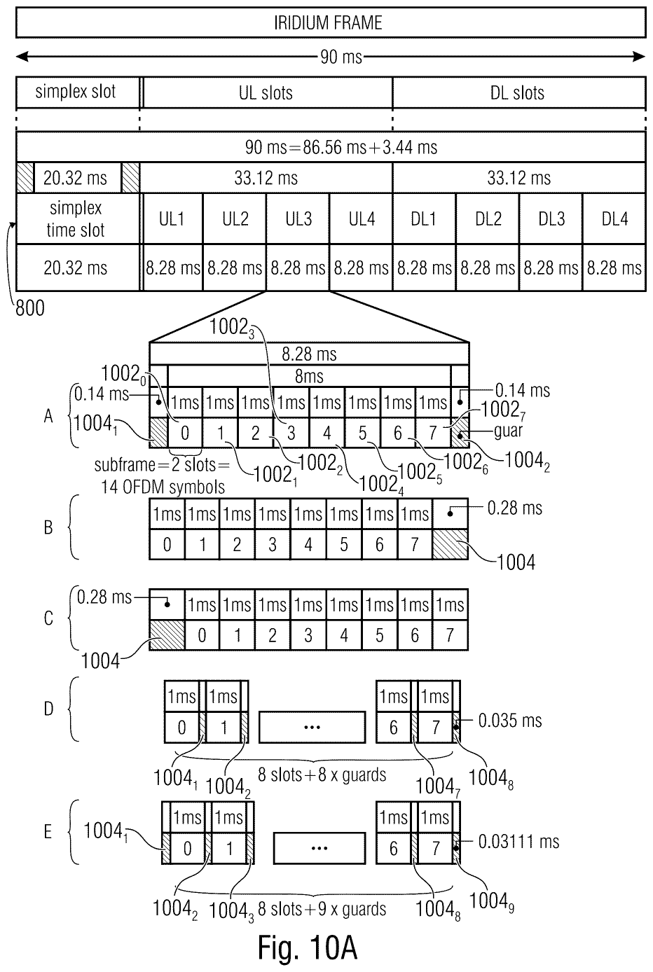

FIG. 9 shows a schematic block diagram of a wireless communications network 900 according to an embodiment that comprises several devices that themselves form embodiments in accordance with the present disclosure. Devices 102ₐ and 102_{b} of wireless communication network 900 may be adapted to communicate by use of an iridium communication system, in accordance with the L-band as described in connection with FIGS. 8a-c. UEs 904₁, 904₂ and 904₃ may be adapted as devices operating in a wireless communications network in an NTN configuration and in a TN configuration, e.g., as an LTE NTN-IoT device, whilst UEs 902ₐ and 902_{b} may be referred to as iridium UEs. Additional UEs such as UE 906ₐ and 906_{b} may be present and it is noted that the UEs 902ₐ, 902_{b} as well as UEs 906ₐ and 906_{b} are optional within the network as is the number of UEs 904 as far as exceeding the number of one. Finally, the embodiments described herein may not be limited to LTE NTN-IoT device, but may also apply to one or more of NR-NTN, NR-NTN-IOT, 6G-NTN, 6G-NTN-IOT, IoT-NTN TDD and IoT NTN half-duplex TDD or NTN half-duplex FDD devices.

A non-terrestrial base station 908, e.g., implemented as satellite S1 of FIG. 1, may provide an unidirectional or bidirectional service link 912.

A part 914₁ of communication provided by non-terrestrial base station 908 may be dedicated to UEs 902ₐ and 902_{b} or a part thereof. A different part 914₂ of the service link 912 may be dedicated to at least one of UEs 904₁ to 904₃ that are adapted to operate according to a different wireless communication scheme, e.g., the LTE scheme or a NR scheme when compared to the iridium scheme that nevertheless provides service as the part 914₂. Part 914₂ may be realized, e.g., as one or more slots 916_{1,2} and/or 916_{2,2} within one or more frames 800₁ and 800₂. As the NB-IOT devices possibly receive a comparatively low amount of service from the respective other wireless communication scheme, e.g., in order to avoid excessive power consumption, the devices 904₁, 904₂ and/or 904₃ may receive a signaling from a terrestrial link or the non-terrestrial link indicating a system frame number of frame 800₁ or 800₂ or a gap between the respective resources 916_{1,2} and 916_{2,2} wherein it is noted that frames 800₁ and 800₂ may be subsequent frames within the wireless communication scheme or may be spaced by at least one further frame. In awareness of the gap or distance in time indicated by such a signal 918, the UEs 904₁, 904₂ and/or 904₃ may wait until the syntax time slot 802₁ or 802₂ indicates the respective system frame number SFN or until a respective gap between the resources 916_{1,2} and 916_{2,2} has been lapsed.

Wireless communication network 900 may further comprise a terrestrial station or gateway 918 communicating with non-terrestrial base station 908 via a feeder link 922. Gateway 918 may be in communication with a terrestrial base station or a core network 924 via a communications link 926.

An advantage provided by the present embodiments is related to allowing an LTE IoT device 904₁, 904₂ and 904₃ to communicate by use of a different wireless communication scheme when compared to the LTE scheme, e.g., provided by the non-terrestrial communication scheme. The described mechanisms may be transferred, without limitations or severe amendments, to different pairs of wireless communication schemes which include TDD duplex scheme. This may be an NTN TDD 5G or 6G wireless communication system or WiFi systems, e.g. WiFi7 or WiFi8 communication systems or any IoT wireless communication system, e.g., IoT NTN wireless communication system.

Embodiments relate to processing a signal transmitted occupying at least one slot that is according to a first wireless communication standard, the at least one slot being included in a frame structure according to a different second wireless communication standard. That is, embodiments address on how to use a slot structure different from the intended one, for nevertheless processing, i.e., transmitting and/or receiving, signals. As a first wireless communication standard embodiments suggest an Iridium structure which is, however non-limiting example only. As a second wireless communication standard embodiments suggest the NB-IOT-LTE which is, however also a non-limiting example only. Other examples of fitting one slot structure to another by use of one or more of the mechanisms described herein to thereby possibly allow to use existing circuitry, infrastructure and/or processing for a different type of signals as provided by the embodiments explicitly described are possible without severe modifications.

The following embodiments comprise of possible mappings of the NB-IOT frame structure to the IRIDIUM frame structure. In the IRIDIUM system, any of the uplink, UL, slot or a downlink, SL, slots can be used to transmit an uplink NB-IOT LTE or a downlink NB-IOT LTE signal. The inventors have found that since the typical IRIDUM slot has a length of 8.28 ms, and the typical LTE subframe consist of a 10 ms radioframe, adaptations may allow to fit an LTE radioframe into the IRIDIUM slot structure. Embodiments described herein may be combined with each other unless explicitly stated otherwise as different ways on how to adapt an LTE (sub) frame to a different frame structure.

Note, that embodiments in this invention may refer to slots or subframes as time units. In general, these terms can be used interchangeable. Furthermore, the time basis can also be just in terms of time resources or time units, where a time resource or unit can be one or more of:
one or more OFDM symbols,
one or more slots or mini-slots or half-slots, e.g., consisting of 14 OFDM symbols,
one or more subframes or half-frames, e.g., consisting of 2 slots,
one or more radioframes or frames, e.g., consisting of more than one subframe, 8 or 10 subframes,
one or more hyperframes or superframes, e.g., consisting of more than one frame or up to 1024 frames or radioframes.

Note that the terms symbol, slot, subframe, radioframe, frame hyperframe, superframe can be used interchangeable.

According to an embodiment, the LTE frame is truncated to 8 subframes consisting of a total of 16 slots. Each subframe has the length of 1 ms, resulting in a shortened length of a radioframe of 8 ms. This truncation can be done in various ways. Since certain LTE subframes in LTE NB-IOT TDD carry a specific function, it may be beneficial to cut out subframes lacking this specific function. Specific functions may be one or more of
A primary synchronization sequency, e.g., PSS or narrowband PSS, NPSS, typically transmitted in subframe 5,
A secondary synchronization sequency, e.g., SSS or narrowband SSS, NSSS, typically transmitted in subframe 9,
A broadcast channel, e.g., PBCH, or narrowband PBCH, NPBCH, typically transmitted in subframe 0,
A broadcast messages transmitted on a broadcast channel, e.g., a system information block, e.g., a SIB1, transmitted in subframe 4.

According to an embodiment that may be realized as an alternative or in addition, the SIB timing might need to be aligned with the IRIDIUM timing, since the SIB periodicity might be too limited in current LTE NB-IOT systems. Thus, additional SIB periodicities should be introduced for the LTE NB-IOT system mapped to the IRIDIUM system or slot structure, e.g., allow periodicities with multiple of 90 ms, e.g., 90 ms, 180 ms, 270 ms, etc. Furthermore, transmission of SIB in current LTE NB-IOT systems may be limited, e.g., only send in every even radioframe. Thus, according to an embodiment, the SIB could be sent in every LTE NB-IOT radioframe mapped to the IRIDIUM system or based on a configured or pre-configure SIB pattern.

Thus, including subframes 0, 4, 5, and 9, would need less changes in the subframe structure when defining a truncated subframe format. Furthermore, according to an embodiment, any 2 out of 10 of the other subframes may be removed from the LTE frame structure to form the truncated radioframe consisting of 8 subframes. According to an embodiment that may be realized as an alternative or in addition, restrictions could be applied, e.g., only allowing to cut 2 consecutive subframes, e.g., subframes 1 and 2, or subframes 7 and 8. Possible subframes sequences would be:
Option 1: [3 4 5 6 7 8 9 0] (across two consecutive radio frames)
Option 2: [4 5 6 7 8 9 0 1] (across two consecutive radio frames)
Option 3: [8 9 0 1 2 3 4 5] (across two consecutive radio frames)
Option 4: [9 0 1 2 3 4 5 6] (across two consecutive radio frames)

The active time duration is the duration during which the DL/UL is active and can be across LTE frames, e.g., slots: [3 4 5 6 7 8 9 0] (across two consecutive radio frames) active as DL.

### Shortened LTE Frame Design

This truncated LTE frame structure would then result in a new LTE radioframe of a length of 8 ms. Different options exist when fitting this into the IRIDIUM slot structure of 8.28 ms, since this would lead to a spare of 0.28 ms.

Since the proprietary IRIDUM system is supposed to operate its synch slot, SIMPLEX, as well as any combination of UL and/or DL slot independent of the NB-IOT LTE system, the system should be designed in a self-contained manner, which implies that any changes to the system should be done without having any impact to the underlying IRIDIUM frame structure. Thus, this may benefit from or may even need a self-contained radioframe design for the NB-IOT LTE system to be embedded within the IRIDIUM timing constraints.

In general, a UE would synchronize to a radioframe and would then need to either be signalled or have the ability to calculate the exact timing, so that it would be able to
Receive and decode the particular radioframe
Transmit a certain radioframe at the correct time instance, e.g., including a pre-calculated timing advance, TA.

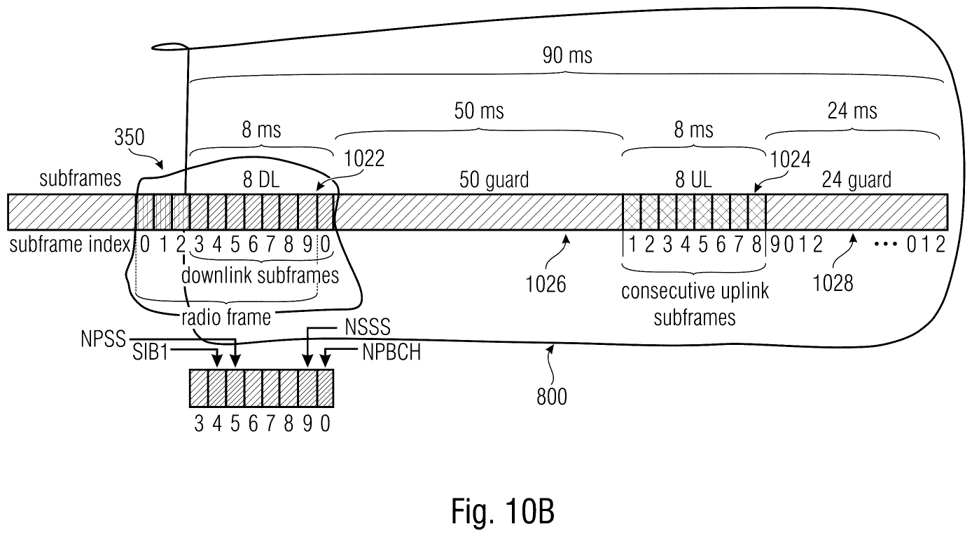

Thus, different options exist when trying to fit the 8 ms LTE radioframe into the 8.28 ms IRIDIUM slot structure, which are depicted as options A, B, C, D, E shown in FIG. 10a in order to adapt a signal from one wireless communications scheme to another.
Option A: including a half guard, e.g., 0.28 ms/2=0.14 ms at the beginning and the end of the radioframe,
Option B: adding a full guard, e.g., 0.28 ms at the end of the radioframe,
Option C: adding a full guard, e.g., 0.28 ms at the beginning of the radioframe,
Option D: adding 0.28 ms/8, e.g., 0.035 ms at the end of each subframe within the radioframe,
Option E: adding 0.28 ms/9, e.g., 0.03111 ms in between all subframes, with a total of 9 guards having the radioframe also begin and end with a guard.

Other, non-equal distributions of the surplus time are possible without limitations.

In case of Option D or Option E, it would also be possible to use the gaps after each symbol as cyclic prefix extension, CPE, e.g., extend each cyclic prefix by a fraction of the gap, e.g., in case of 14 OFDM symbols per subframe, each OFDM symbol could be extended, e.g., in case of 112 OFDM symbols per truncated LTE radioframe, by

$$0.28 ms / ( 14 * 8 subframes ) = 0.28 ms / 112.$$

This CPE could be used to improve performance in scenarios suffering under multi-path fading effects.

By fixing the above structure, the timing would be well-defined, so that there could be a fixed mapping of the 8 ms LTE radioframe to the IRIDIUM slot structure across frames and superframes, e.g., consisting of a number of frames.

Note, that in the context of a 4G LTE communication system, a hyper frame refers to a superframe structure that consists of multiple radio frames. A hyper frame typically includes several radio frames, each of which contains several subframes. This hierarchical structure helps organize and synchronize the transmission of data in the LTE network, ensuring efficient and reliable communication between the base station and the mobile device. The hyper frame is used to coordinate the timing and sequencing of data transmission and reception, as well as to manage the allocation of resources within the network. Note that a hyper frame may be associated with index number, e.g., a hyper SFN or H-SFN, which is an index broadcasted in the system information that increments at every system frame number, SFN, wrap around, i.e., every 10.24s in LTE. Note that in embodiments of this invention, the wrap-around of the modified LTE NB-IOT structure may have to be aligned with the IRIDIUM frame structure, in order to account for the differences in timings.

According to an embodiment, e.g., in case a larger guard should be fixed between IRIDIUM UL to DL slot switching, certain rules could be applied, such that the UL to DL slot boundary could be fixed to use or need the full guard, e.g., 0.28 ms at the end of the UL slots, e.g., UL4, and/or at the beginning of the DL slots, e.g., DL1. This would result in a switching gap of at least 2x 0.28 ms=0.56 ms, between the 4 IRIDIUM UL and 4 IRIDIUM DL slots.

FIG. 10a shows a schematic representation of options A-E described above. The excessive or surplus time that remains when using time according to one wireless communication scheme, e.g., 8 slots according to LTE, in a different communications scheme, e.g., a slot according to the iridium scheme, so for example 0.28 milliseconds may be used as additional guard time or guard period.

According to an embodiment described herein, to adapt to the second communication scheme a truncated LTE frame is fit to a radioframe having an Iridium frame structure according to an Iridium Communication System, ICS, to use the second number of slots, wherein a remaining time of the Iridium frame structure is assigned according to one of
Option A: including a half guard, e.g., 0.28 ms/2=0.14 ms at the beginning and the end of the radioframe,
Option B: adding a full guard, e.g., 0.28 ms at the end of the radioframe,
Option C: adding a full guard, e.g., 0.28 ms at the beginning of the radioframe,
Option D: adding 0.28 ms/8, e.g., 0.035 ms at the end of each subframe within the radioframe,
Option E: adding 0.28 ms/9, e.g., 0.03111 ms in between all subframes, with a total of 9 guards having the radioframe also begin and end with a guard.

According to an embodiment described herein, in case of Option D or Option E, gaps after each symbol are used as cyclic prefix extension, CPE.

According to an embodiment described herein, the wireless communication device is adapted to operate according to a guard interval between an UL to DL slot switching of the second communication scheme, comprising excessive time of a prior first frame at an end thereof and excessive time of a subsequent second frame at a beginning thereof to combine the excessive times for the guard interval to adapt to the second communication scheme.

According to option A, LTE subframes 1002₀ to 1002₇, e.g., 8 LTE slots may be used from an iridium slot such as uplink slot 804₃ being an uplink slot whilst the disclosure refers to downlink slots without limitation. The remaining time of 0.28 milliseconds may be used equally prior to the first subframe 1002₀ and after the last of 8 subframes 1002₇.

According to option B, a guard 1004 occupying at least a part or even all of the surplus time may be arranged at the end of the radio frame. As an alternative, guard 1004 may be located prior to the first guard as shown for option C.

According to option D, the surplus time is divided into 8 parts of equal length and added after each subframe whilst according to option E, as another example, the surplus time is divided into 9 parts 1004₁ to 1004₉ and arranged so that each subframe is sandwiched between two guard periods 1004. As described earlier, the amount of time and/or the arrangement may also be asymmetrical, e.g., adding a guard period of different lengths and/or adding guard periods only at certain positions whilst not arranging the guard periods at other locations such as having no guard period or a shorter guard period between two subframes when compared to another pair of subframes.

Slot Allocation within IRIDIUM Frame

According to an embodiment, more than one IRIDIUM slot, e.g., UL1-4 or DL1-4 could be utilized for transmission of a NB-IOT LTE frame. Here any combination of consecutive or non-consecutive slots could be occupied by an NB-IOT LTE frame. Examples are depicted below. Depending on the number of IRIDIUM slots to be selected, according to

$$C ( n , k ) = n ! / ( k ! ( n - k ) ! )$$

where n=8 is the number of total slots which can be utilized, and k being the number of actual slots that are selected, this could result in:
1:8 options,
2:28 options,
3:56 options,
4:70 options,
5:56 options,
6:28 options,
7:8 options,
8:1 option selecting all UL and DL slots.

Embodiments provide a user device of a wireless communication system, e.g., of a terrestrial network such as an NB-IOT network. The user device or NB-IOT UE may receive a control message containing information on a frame structure of a different wireless communication system such as an IoT NTN TDD system or a different terrestrial or non-terrestrial network, e.g., using a different radio access technology, RAT. The user device may receive the same or a different control message or may be configured or pre-configured with an information containing at least one or more of
information on the frame and slot numbers to be used for DL based on the first communication scheme frame structure, e.g., which slots within the first communication scheme frame is used for DL;
information on the frame and slot numbers to be used for UL based on the first communication scheme frame structure, e.g., which slots within the first communication scheme frame is used for UL;
Information on the timing gap being between the start/end of DL active time duration to the start/end of UL active time duration or vice versa.
Information on a timing gap between DL and UL active duration.

That is, via the control message and/or via a configuration or pre-configuration, the device may be informed about the two schemes that are to be matched. Optionally, this may include further parameters such as where to add or skip guard times, e.g., as described in connection with FIG. 10a and/or 12. The device may thus be in knowledge which scheme is to be implemented for its communication and may adapt, e.g., the IoT scheme used for LTE IoT to fit the NTN scheme, e.g., by shortening the LTE IoT frame, e.g., from 10 to a number of 8 subframes and/or to add additional guards. The way of adding guards may be known at both sides to enhance error free communication.

Independent from receiving such a control message, but also in combination therewith, a device described herein, e.g., a user device such as a NB-IOT UE, may be configured for processing, e.g., transmitting and/or receiving signals that are transmitted to occupy at least one of a slot, a subframe and a radioframe, the signal being in accordance with a second wireless communication scheme such as IoT NTN TDD. Such a signal is an adaptation of a different first communication scheme such as NB-IOT in LTE, wherein based on the adaptation, the signals fits the second communication scheme.

A frame structure type 1 used for IoT NTN TDD according to an embodiment is shown in FIG. 10b. In the given example, the IoT NTN TDD system may utilize a predetermined number of e.g., 8 subframes of the 10 subframes of a radio frame of the frame structure type 1. For downlink, DL, a specific subframe order may be chosen (3, 4, 5, 6, 7, 8, 9, 0) in such a way, that the control and broadcast channels which are transmitted on specific subframe indices, e.g., SIB1 on subframe 4, NPSS on subframe 5, NSSS on subframe 9, and/or NPBCH on subframe 0, described in connection with FIG. 3c can be received by the IoT NTN TDD device. The device may determine the subframes usable from the set 1022 of downlink subframes based on such information.

By using additional guard times, the obtained subframe order may fit into a predefined schedule or time length, e.g., a time length of 90 ms. That is, the device is not necessarily required to know about the system to which it fits its communication. It may be sufficient to obtain respective information or be configured or pre-configured with such information. For example, the timing may be obtained from system data or synchronization data such as data obtained from a random access preamble. Being aware about the timing to fit and possibly some anchors or reference timings, e.g., a first downlink subframe, a last downlink subframe, a first uplink subframe, a last uplink subframe or the like, the device may also include or implement guard times.

For example, the successive guard period subframes 1026 may be chosen in such a way, e.g., 50 subframes, that a potential uplink frame 1024 may consist of 8 consecutive uplink subframes, numbers 1, 2, 3, 4, 5, 6, 7, 8. The successive 24 guard subframes 1028 may be chosen in such a way, that the next downlink radio frame will start at subframe 3 again. Thus, the IoT NTN TDD device can decode a well-defined and constant subframe structure for the downlink frames using a modified frame structure type 1 which is truncated to 8 subframes.

According to an embodiment of an advantageous implementation, a device such as a UE described herein is adapted to adapt the signal to fit the second communication scheme based on receiving a channel such as a broadcast channel in accordance with the second communication scheme. Alternatively or in addition, the device may be adapted to process the signal in accordance with the first communication scheme based on receiving a channel such as a broadcast channel in accordance with the first communication scheme. That is, based on the respective channel the device may determine whether the adaptation of the signal or the processing thereof is necessary or not and may operate accordingly.

For example, a NB-IOT device may determine, whether a downlink subframe or a TDD special subframe that is configured for NB-IOT DL transmission is an NB-IOT DL subframe. For example, if the UE determines that the subframe contains one or more of NPSS, NSSS, NPBCH, and SIB, such as SystemInformationBlockType1-NB transmission, then this device may determine that the subframe is not a NB-IOT subframe. Therefore, if the UE is in coverage of a different network, such as an NTN, e.g., being served by an IoT NTN TDD device and the UE determines the subframe being different from the pre-defined number of consecutive downlink subframes according to the defined frame structure, e.g., type 1, for IoT NTN TDD, then the subframe may be considered to be not an NB-IoT-DL subframe. For the uplink, an NB-IoT device may determine whether the subframe is an NB-IOT uplink subframe. However, for TN TDD, a NB-IOT device may determine that a subframe is an NB-IOT UL subframe if, for an NB-IOT carrier, it is configured as NB-IOT UL subframe, e.g., via a higher layer. For IoT NTN TDD, the NB-IOT UE may assume a subframe as a NB-IoT UL subframe if it is one of the consecutive uplink subframes 1024 according to the respective frame structure, e.g., type 1, for the IoT NTN TDD.

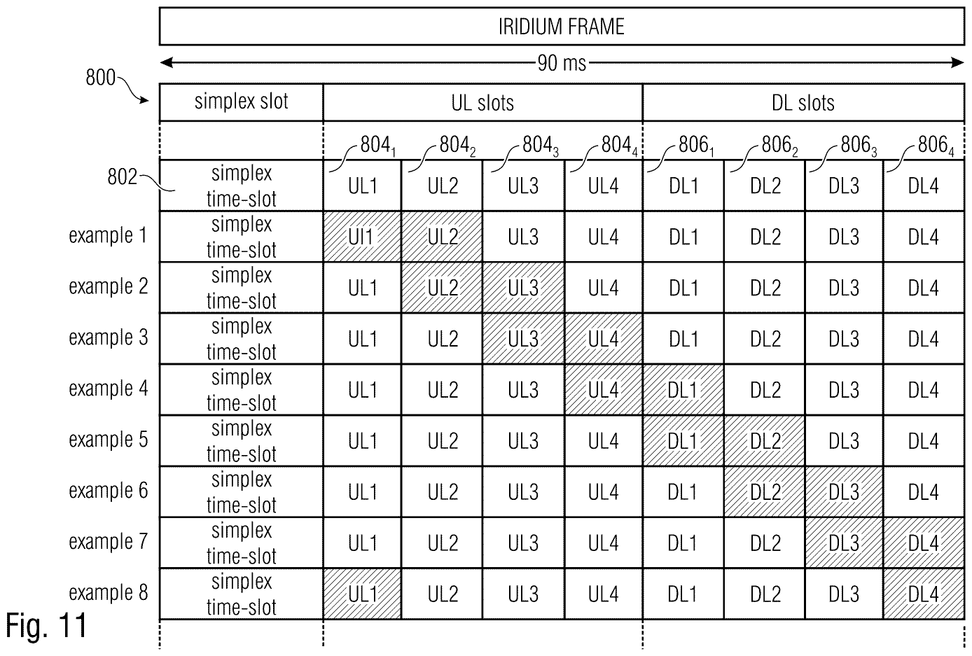

FIG. 11 shows a schematic representation related to selecting one or more IRIDIUM slots for LTE NB-IOT transmissions. FIG. 11 shows a schematic representation of possibilities of using two adjacent slots in uplink and/or downlink of iridium frame 800 for LTE schemes. In example 1, uplink slots 804₁ and 804₂ are selected. In example 2, uplink slots 804₂ and 804₃ are selected. In example 3, uplink slots 804₃ and 804₄ are selected. In example 5, uplink slot 804₄ and downlink slot 806₁ are selected. In example 5, downlink slots 806₁ and 806₂ are selected, in example 6 there are selected downlink slots 806₂ and 806₃ and in example 7, downlink slots 806₃ and 806₄ are selected. In example 8, there are selected downlink slot 804₄ and uplink slot 804₁ which may be two adjacent slots when considering subsequent iridium frames. However, it is neither necessary that there is selected a number of two slots, e.g., only one slot or more than two slots may be selected. Furthermore, a plurality of selected slots is not required to be adjacent to one another, i.e., they can be spaced within the frame or multiple frames.

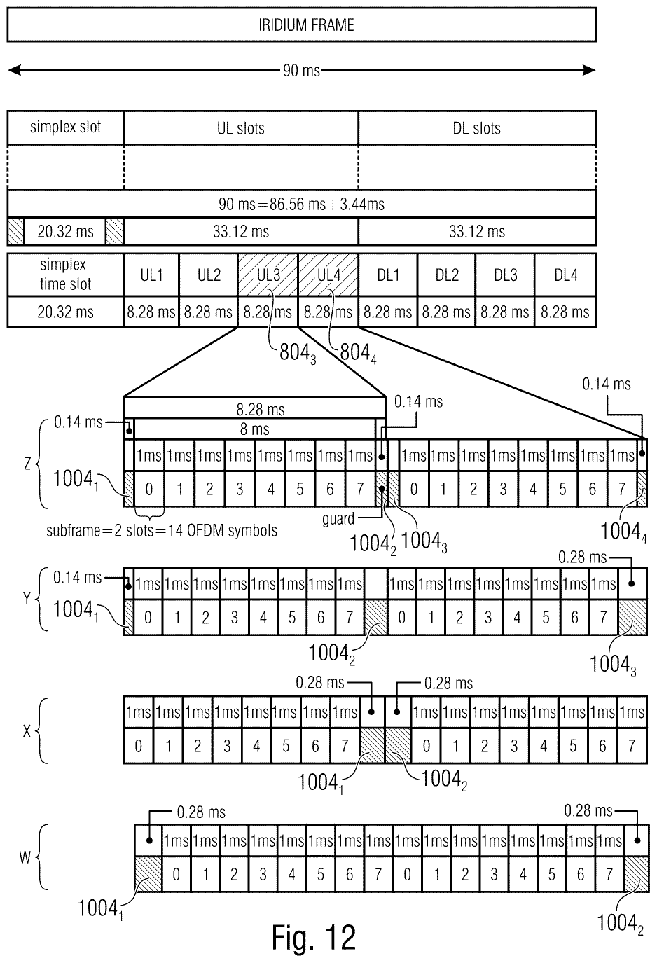

With regard to FIG. 12 and making reference to the description provided in connection with FIGS. 10 and 11, the surplus time obtained by mapping LTE subframes to iridium frames may be dynamically mapped to subsequent slots of the frame such as uplink slots 3 and 4, i.e., 804₃ and 804₄ according to example 3 of FIG. 11 may be selected according to a non-limiting example. Guard periods may be implemented equally in the slots, e.g., each according to example A as indicated in example Z in FIG. 12. As an alternative and as shown in example Y, slot 804₃ may be equipped with guard periods according to example A of FIG. 10a whilst the next slot or the following slot 804₄ may be equipped with the guard period according to example B of FIG. 10a.

According to example X, the preceding slot may be equipped with the guard period according to example B, whilst the subsequent slot may be equipped with the guard period according to example C of FIG. 10a allowing for a long guard period between the two slots.

Example W shows a complementary configuration when compared to example X where guard periods of 0.28 milliseconds are located prior to the first LTE subframe and after the last LTE subframe.

According to an embodiment, the location and/or the amount of guard period may be selected based on a certain optimization criterion in order to extend the duration of the configuration according to the first communication scheme to fit the second communication scheme of vice versa.

According to an embodiment, additional restrictions could be applied, e.g.,
Only UL slots can be selected within a single IRIDIUM frame,
Only DL slots can be selected within a single IRIDIUM frame,
Only consecutive slots can be selected,
Only non-consecutive slots can be selected, e.g., gaps between slots,
Between UL and DL slots selected, there has to be a gap of at least n other slots, e.g., n>1, etc.

The selected pattern needs to be signalled. Furthermore, in case of non-consecutive slots, the gaps between slots needs to be signalled. In addition, in case there is an association between UL and DL slots, this could be indicated to the UE by explicit signalling or, it could be implicitly interpreted by a UE, that in case one or more slots are allocated for a said UE in DL within an IRIDIUM frame, other UL slots declared for NB-IOT LTE usage would be associated with the same UE, or vice versa.

In a further embodiment, the configured pattern or allocation pattern may depend on one or more of
Paging occasion opportunities, for the said UE,
Pattern used for discontinuous reception, DRX pattern, for the said UE, e.g., the UE performing power saving or with enhanced power saving requirements,
Support a pattern with a period of 9 radio frames for the target MSS allocated band, where the number of downlink, D, and uplink, U, slots are fixed, e.g., to a number of 8 slots, with a fixed guard period.
   Slot allocation across IRIDIUM Frames

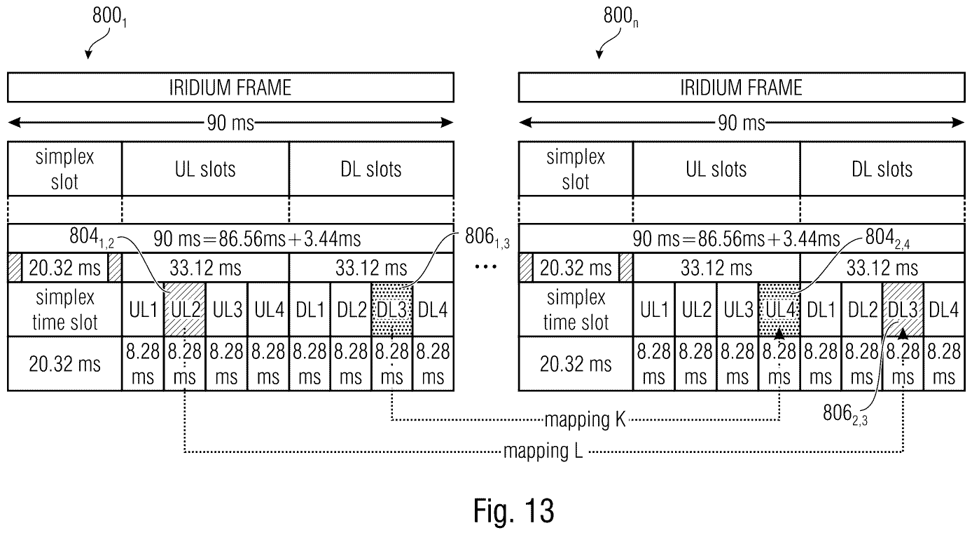

Mapping across IRIDIUM frames, examples are depicted in FIG. 13. Mappings or associations can be between DL-UL, UL-DL, DL-DL, UL-UL IRIDIUM slots. The

DL active time duration in LTE should overlap with the DL slot in IRIDIUM frame and the UL active time duration in LTE should overlap with the UL slot in IRIDIUM frame. Thus, there will be some gap between the DL and UL active time durations. Further, the depending on this gap, the DL slot overlapping with the DL active time duration and the UL slot overlapping with the UL active time duration will be linked. This linking is shown in FIG. 13 where DL3 806_{1,3} can be linked as mapping K to UL4 804_{2,4} or to UL2 804_{1,2} as mapping L when considering DL3 as 806_{2,3} resulting in different mappings.

Some embodiments described herein relate to a configuration and a timing for a start or end of a DL active time duration with regard to a following start or end of UL active time duration. Whilst not preventing a configuration vice versa, this may lead to a gap in time comprising at least one additional time duration of a simplex time slot being part of the next IRIDIUM frame, not preventing additional of such slots if the time gap is longer.

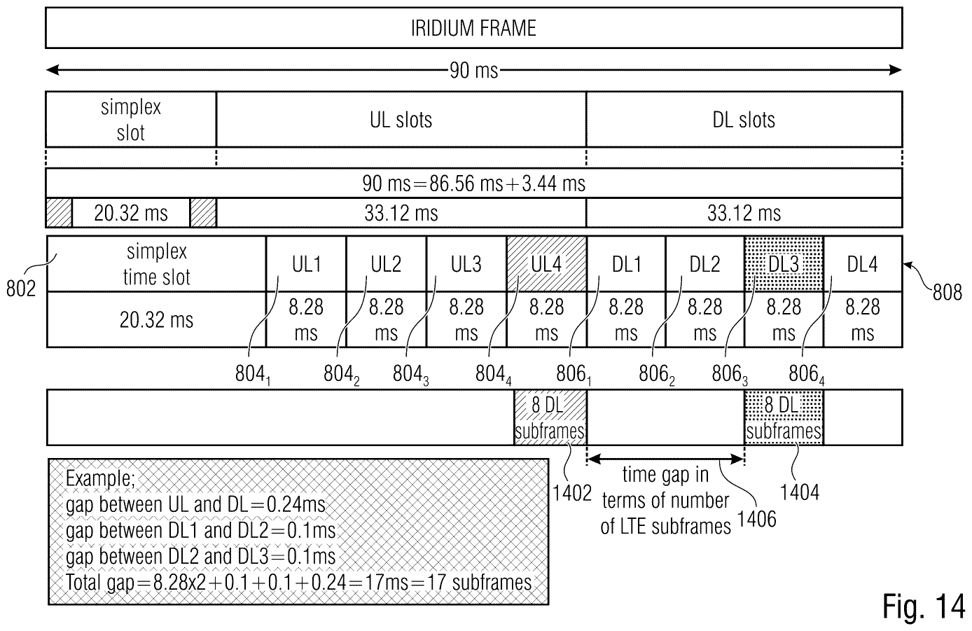

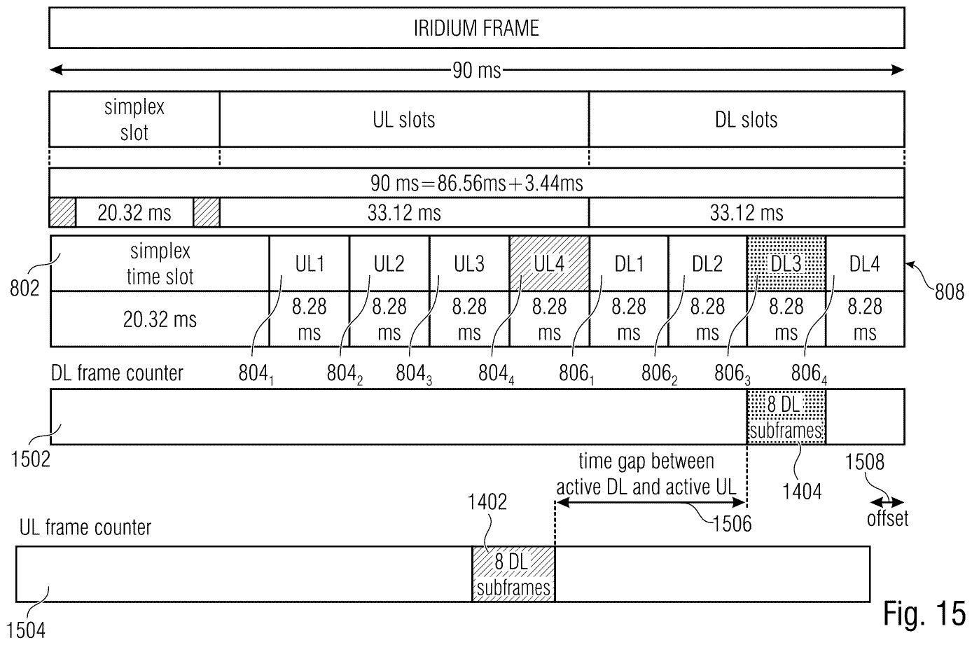

The various timing related information can be configured or pre-configured to a UE using one or more of:
Information on IRIDIUM frame structure, e.g. one or more of:
   Time gap between consecutive UL slots
   Time gap between consecutive DL slots
   Time gap between UL and DL slot
   Time gap between DL and UL slot (includes the Simplex time slot)
   Simplex time slot duration
Information on the frame and slot numbers to be used for DL based on LTE frame structure, e.g., which slots within the LTE frame is used for DL.
Information on the frame and slot numbers to be used for UL based on LTE frame structure, e.g., which slots within the LTE frame is used for UL.
Absolute timing gap between DL and UL active duration, e.g., in milliseconds, ms.
The timing gap is between the start/end of DL active time duration to the start/end of UL active time duration or vice versa.
Timing gap between DL and UL active duration in terms of one or more of the following)
   Duration of Simplex slot
   Total duration of each UL/DL slot in IRIDIUM frame structure (including gaps) and number of UL and/or DL slots
   Any other gap duration
Timing with respect to IRIDIUM numbering of slots/frames/Simplex slot
   timing gap between DL and UL active duration in terms of the numbering, e.g., the gap is 20 slots and 1 Simplex duration
Timing with respect to LTE radioframe/slots/subframes numbering, e.g. one or more of:
   timing gap between DL and UL active duration in terms of the numbering, e.g., the gap is 2 radio frames/17 subframes.
   For some alignment, the gap between the DL and UL active time duration can be in terms of an integer multiple of subframes as shown in FIG. 14. E.g., here the alignment is, by way of example only:
   the start boundary of DL active time duration aligns with the start boundary of DL3 806₃ (excluding gap),
   the end boundary of the UL active time duration aligns with the end boundary of UL4 804₄ (excluding gap)
   Thus, multiple such alignments between the DL/UL active time durations and IRIDIUM slots are possible, e.g. one or more of:
      The gap 1406 is given in terms of integer number of subframes in LTE
      The alignment for UL and/or DL active time durations are provided
      The mapping between the DL active time duration and UL active time duration is provided. For example, DL active time duration corresponds to DL3 806₃
According to an embodiment, the gap 1506, carrying a similar information as gap 1406 is provided in terms of number of active time durations. For example, the gap 1506 may be equal to 2 active DL time durations which will be 16 (2×8) LTE subframes.
According to an embodiment, separate LTE frame/subframe counters 1502 and 1504 are maintained for UL 1402 and DL 1404 as shown in FIG. 15. According to an embodiment, the offset or time gap 1508 between the UL and DL frames is provided to the UE. The offset 1508 can be in absolute time. For example, the offset 1508 can be the difference between the time boundaries of OFDM symbols of the 2 DL and UL frame counters 1502, 1504 respectively. According to an embodiment, the DL and UL active time duration is provided as subframe numbers. The offset is such that both DL and UL active time durations are aligned to any of the DL and UL slots of IRIDIUM frame structure. The UE may transmit in one link direction, e.g., UL or DL, within one frame only. For this, it may use a dedicated counter, e.g., a UL frame counter or DL frame counter, in order to keep track of UL or DL slots within a frame or radioframe. Furthermore, frame counters may depend on the frame structure used or utilized by the corresponding base station, e.g., the BS may only utilize certain UL and/or DL slots for communication, any may also adapt this depending on a criterion, e.g., how many devices are present in the communication scenario, or in case of NTN, depending on the position of the satellite, e.g., in case this is a non-stationary satellite.

With regard to FIG. 14, a time structure of an iridium frame in accordance with the description provided regarding FIGS. 8a-c is shown. Uplink resources 1402 and downlink resources 1404 of the iridium frame 800 may be occupied as described, for example, in connection with FIG. 10a and/or FIG. 12. That is, the use of a single uplink slot 804₄ and of a single downlink slot 806₃ is selected as an non-limiting example only and additional uplink slots and/or additional downlink slots may be used. As a further alternative only uplink resources or only downlink resources may be occupied.

With reference to the selected resources, a time gap 1406 between uplink and downlink resources may be dependent from or at least based on the selected resources and the structure of the iridium frame. For example, a gap between uplink and downlink may be set to 0.24 milliseconds, a gap between two adjacent downlink slots may be set to 0.1 milliseconds, e.g., between downlink slots 806₁ and 806₂ and between downlink slots 806₂ and 806₃. The gap 1406, in the example of FIG. 14, may sum up to two times 8.28 milliseconds plus 0.1 milliseconds plus 0.1 milliseconds plus 0.24 milliseconds equal 17 milliseconds which may correspond to 17 subframes in the LTE schedule.

### Frequency Diversity

According to an embodiment, the NTN-IoT radioframe can utilized one or more anchor frames. An anchor frame is a configure or pre-configured frame.

In NTN Narrowband IoT (NB-IOT) in LTE, an anchor frame is defined as a reference point in the downlink frame structure where a device can synchronize and obtain the needed timing and control information to communicate with the network. This anchor frame typically contains specific synchronization signals and control information that allow the device to establish and maintain a connection with the base station. By synchronizing to the anchor frame, the device can accurately receive and transmit data within the NB-IOT network.

According to an embodiment that may be realized as an alternative or in addition, any frame and/or anchor frame can utilize different frequency resources over the time domain, e.g., in order to increase the frequency diversity. This can comprise of frequency hopping of one or more of
a whole radioframe,
a subframe or slot,
a frequency comb,
a pattern of frequency resources, e.g., based on a bitmap.

Note, that a resource in frequency domain can vary over time, based on a random hopping pattern, or based on a fixed hopping function, or based on a fixed frequency shift within sequential frequency hops.

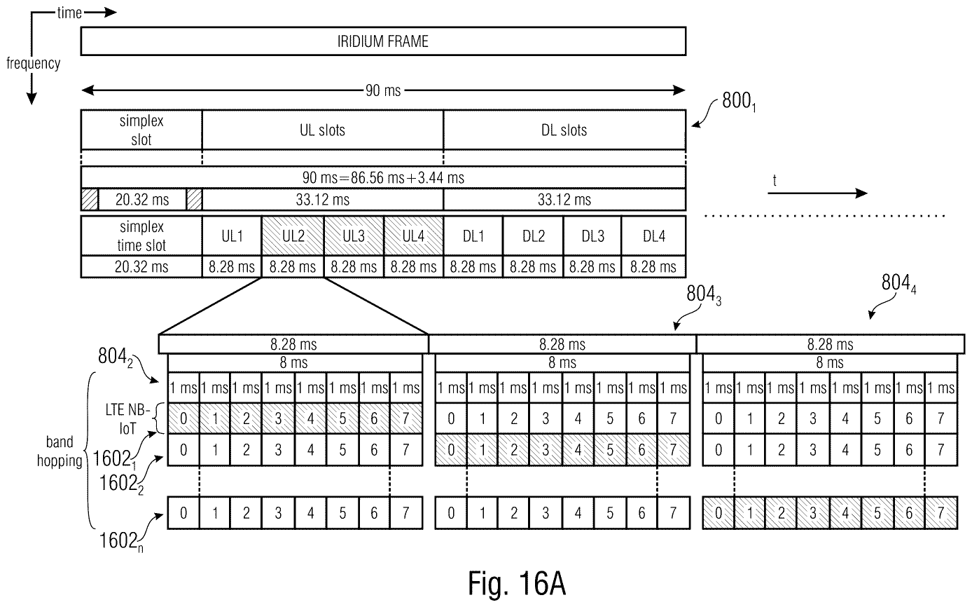

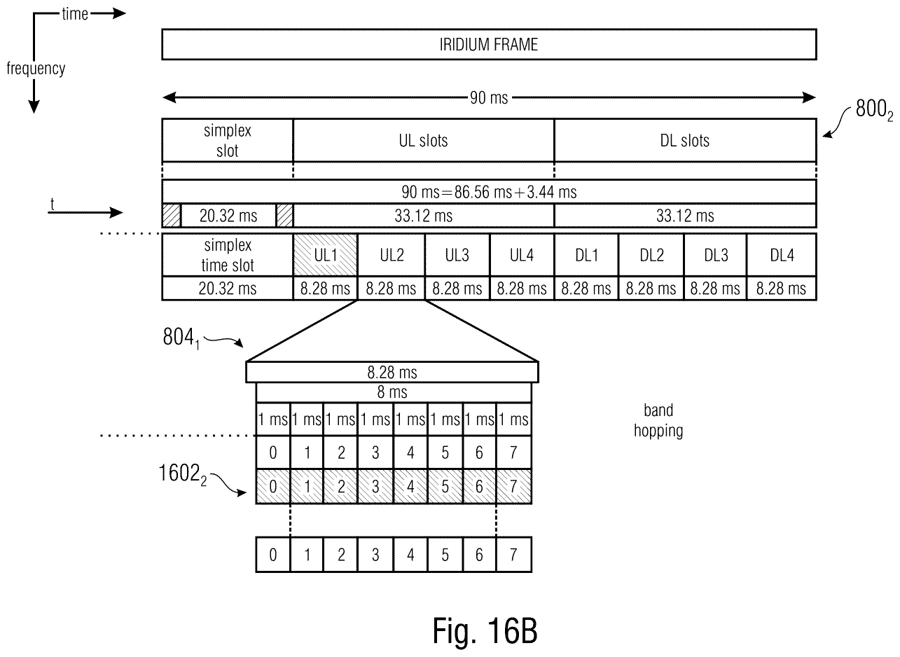

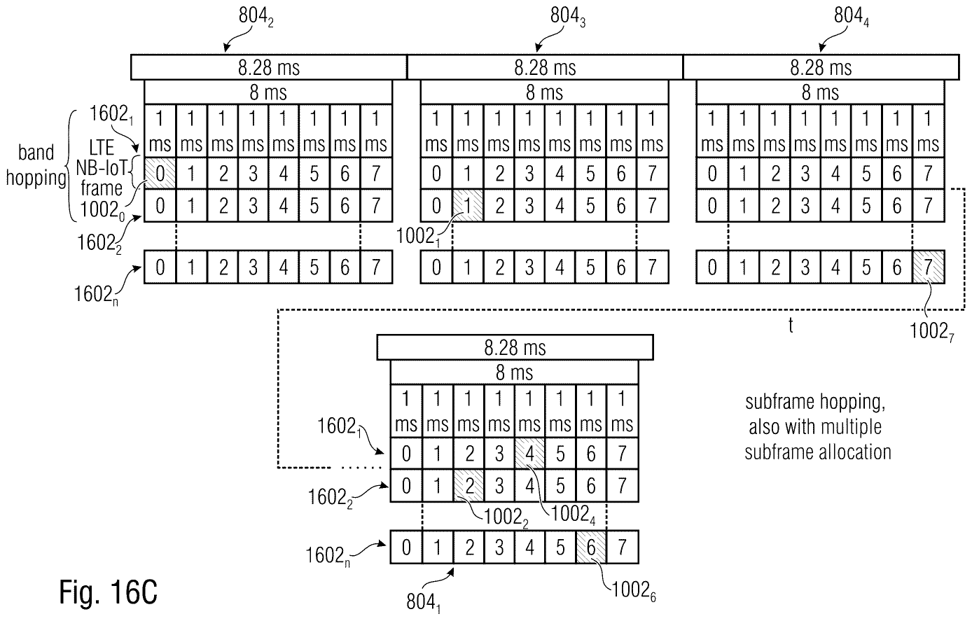

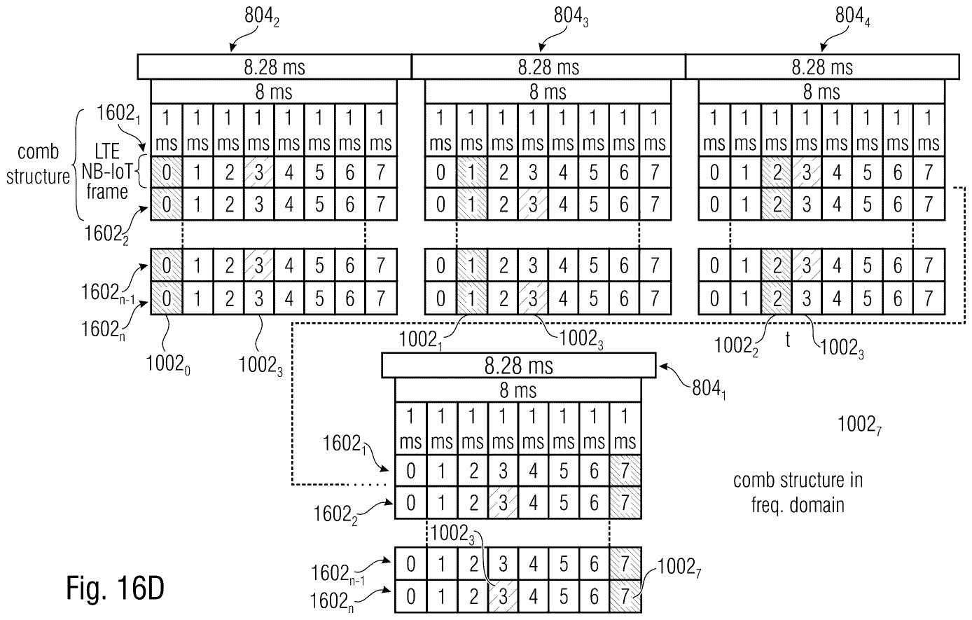

As shown in FIGS. 16a to 16d several possibilities for implementing the frequency hopping exist. In FIG. 16a there is shown the structure of iridium frame 800₁ as described, for example, in connection with FIGS. 8a-c. In the given example, at least one, e.g., three, uplink slots 804₂, 804₃ and 804₄ are used for providing uplink by the UE.

In each uplink slot, an LTE MB-IOT frame in accordance with embodiments may be transmitted, e.g., comprising 8 LTE subframes 1002 as described in connection with FIG. 10a, resulting e.g., in a time of 8 milliseconds occupied within the iridium slot. Without any limitation, additional gaps may be provided as described in connection with FIG. 10a and/or FIG. 12 to fill up the surplus time. For different uplink slots of the iridium frame 800, i.e., different LTE MB-IoT frames, different bands 1602₁, 1602₂, 1602ₙ may be used by the MBE for the frequency hopping.

FIG. 16b shows a schematic representation of an iridium frame 800₂ following iridium frame 800₁ of FIG. 16a as indicated by the timeline t. For uplink slot 804₁ of iridium frame 800₂ the same or a different band 1602 as for the previous uplink slots may be used. As indicated earlier, the change in the frequency band may be based on a random distribution, a predefined pattern or a function.

In FIG. 16c there are shown the same slots 804₂, 804₃ and 804₄ of iridium frame 800₁ and slot 804₁ of iridium frame 800₂ of FIGS. 16a and 16b whilst the frequency hopping relates to a subframe hopping to use a single LTE subframe in each iridium slot 804₂, 804₃ and 804₄ and multiple LTE subframes as shown for iridium slot 804₁. For different subframes different bands 1602₁ to 1602ₙ may be used. Whilst not preventing a use of a same band 1602 within a slot 804 it may be of advantage to use different bands as shown for uplink slot 804₁.

In FIG. 16d there is shown a further variant of the frequency hopping being in accordance with embodiments described herein. By way of example, in each of the uplink slots 804₂, 804₃ and 804₄ as well as the 804₁ of the subsequent iridium frame there are used resources for not only two, which is also possible, but two LTE subframes, e.g., LTE subframes 1002₀ and 1002₃ in uplink slot 804₂, subframe 1002₁ and 1002₃ in uplink slot 804₃, subframe 1002₂ and 1002₃ in uplink slot 804₄ and subframes 1002₃ and 1002₇ in uplink slot 804₁. This does not prevent to use additional subframes and/or additional or less uplink slots or different uplink slots. In the given example, a varying resource may occupy two or more, even all bands 1602, e.g., subframe 1002₀ varying to 1002₁ in slot 804₃, varying to subframe 1002₂ in slot 804₄ and varying to subframe 1002₇ in uplink slot 804₁. Different resource may occupy the same subframe, e.g., subframe 1002₃ but may vary, for example, in view of the selected bands such that only a subset of available bands is used. The use pattern may be random, according to a function or the like but may also be repetitive as shown in FIG. 16d. The shown structure may be understood as a comb structure in the frequency domain as using some of the frequency bands but not necessarily all.

### Signalling

Signalling of information described herein, e.g., information provided to the UE or by the UE may be done via
Broadcast channel, BCH, e.g., SIB, e.g., SIB1, etc.
Control signalling, e.g., RRC,
MAC-CE
PHY control, e.g., a DCI pointing to a future time instance

In the following, additional embodiments and aspects of the invention will be described which can be used individually or in combination with any of the features and functionalities and details described herein.

A first aspect relates to a wireless communication device, e.g., a user device, configured for processing [TX/RX] a signal transmitted occupying at least one slot/subframe/radioframe that is according to a second wireless communication scheme;

wherein the signal is an adaptation of a first communication scheme to fit the second communication scheme.

According to a second aspect when referring back to the first aspect, the adaptation comprises one or more of:
a change in a number of slots/subframes from the first wireless communication scheme, e.g., from a number of 10 slots/subframes to a number of 8 slots/subframes;
an addition of a gap between two slots/subframes of the first communication scheme and/or at the beginning and/or end of the at least one slot/subframe,
an addition of a synchronization structure to the at least one slot/subframe,
an offset or shift, e.g., a time shift, of the first slot of the one or more slots.

According to a third aspect when referring back to the first or second aspect, the device is adapted to adapt the signal to fit the second communication scheme based on receiving a channel such as a broadcast channel in accordance with the second communication scheme.

According to a fourth aspect when referring back to any one of the first to third aspects, the device is adapted to process the signal in accordance with the first communication scheme based on receiving a channel such as a broadcast channel in accordance with the first communication scheme.

According to a fifth aspect when referring back to any one of the first to fourth aspects, the device is to adapt to process the signal in accordance with a first or second communication scheme based on a pre-configuration and/or device capability, e.g., based on a device category or device capability information exchanged with a base station.

According to a sixth aspect when referring back to any one of the first to fifth aspects, the device is adapted to assume signals to be transmitted, e.g., by a base station, in a subset of subframes of a radio frame, e.g., according to a frame structure type 1, namely in the downlink subframes 3, 4, 5, 6, 7, 8, 9, 0.

According to a seventh aspect when referring back to any one of the first to sixth aspects, the device is adapted to transmit in a subset of subframes of a radio frame, namely in 8 consecutive uplink subframes, e.g., subframes 1, 2, 3, 4, 5, 6, 7, 8.

According to an eighth aspect when referring back to any one of the first to seventh aspects, the device is adapted to not transmit on any subframe other than the 8 consecutive uplink subframes, e.g., subframes 1, 2, 3, 4, 5, 6, 7, 8.

According to a ninth aspect when referring back to any one of the first to eighth aspects, the device is configured with 50 consecutive guard period subframes following the 8 downlink subframes.

According to a tenth aspect when referring back to any one of the first to ninth aspects, the device is configured with 24 consecutive guard period subframes following the 8 uplink subframes, e.g., in each 90 ms interval.

According to an eleventh aspect when referring back to any one of the first to tenth aspects, the wireless communication device is adapted to transmit or receive a message, e.g., in a System Information Block, SIB, referring to a synchronization reference anchor allowing to determine the location of the SIB received relative to an overall frame structure.

According to a twelfth aspect when referring back to any one of the first to eleventh aspects, the slots/subframe/radioframe contains an anchor carrier comprising one or more of
a broadcast information, e.g., MIB or SIB or SIB1, transmitted via BCH,
a synchronization signal, e.g., PSS or SSS,
control,
data.

According to a thirteenth aspect when referring back to any one of the first to twelfth aspects,

the slots/subframe/radioframe contains an non-anchor carrier comprising one or more of
a broadcast information, e.g., MIB or SIB or SIB1, transmitted via BCH,
a synchronization signal, e.g., PSS or SSS,
control,
data.

According to a fourteenth aspect when referring back to any one of the first to thirteenth aspects, the anchor carrier points to one or more non-anchor carriers or the non-anchor carrier refers to one or more anchor carriers.

According to a fifteenth aspect when referring back to any one of the eleventh to fourteenth aspects, the wireless communication device is adapted to transmit or receive the message in one or more slots of one or more frames inside a superframe or hyperframe structure.

According to a sixteenth aspect when referring back to any one of the eleventh to fifteenth aspects, a location of the SIB within the one or more frames and/or a location of the one or more frames containing the SIBs is static, semi-persistent or variable in time.

According to a seventeenth aspect when referring back to any one of the first to sixteenth aspects, the wireless communication device is configured for processing the signal transmitted occupying at least one slot/subframe that is according to a first wireless communication standard as the first communication scheme, the at least one slot/subframe optionally being included in a frame structure according to a different second wireless communication standard as the second communication scheme.

According to an eighteenth aspect when referring back to any one of the first to seventeenth aspects, the wireless communication device is configured for operating according to a wireless communication scheme/standard as the first communication scheme and defining a first frame structure comprising a plurality of slots having a slot structure;

receiving a signal indicating or configuring or pre-configuring to use the slot structure in a second frame structure of a different communication scheme/standard as the second communication scheme; and to operate accordingly.

According to a nineteenth aspect when referring back to the eighteenth aspect, the signal comprises one or more of
a configuration for the wireless communication device,
an instruction for the wireless communication device,
a request for the wireless communication device,
a data signal.

According to a twentieth aspect when referring back to any one of the first to nineteenth aspects, the first communication scheme operates in a TDD or FDD mode.

According to a twenty-first aspect when referring back to any one of the first to twentieth aspects, the second communication scheme operates in a TDD or FDD mode.

According to a twenty-second aspect when referring back to any one of the first to twenty-first aspects, the first communication scheme contains
a synchronization, sync, or
a synchronization, sync, structure being different to the synchronization structure of the second communication scheme.

According to a twenty-third aspect when referring back to any one of the first to twenty-second aspects, the first communication scheme is not configured with a synchronization structure and/or
is configured to use a synchronization structure of the second communication scheme.

According to a twenty-fourth aspect when referring back to any one of the first to twenty-third aspects, the second communication scheme contains
a synchronization, sync, or
a synchronization, sync, structure being different to the synchronization structure of the first communication scheme.

According to a twenty-fifth aspect when referring back to any one of the first to twenty-fourth aspects, the second communication scheme
is not configured with a synchronization structure and/or is configured to use a synchronization structure of the first communication scheme.

According to a twenty-sixth aspect when referring back to any one of the first to twenty-fifth aspects, the wireless communication device is adapted for a wireless communication system, WCS, operating according to the first communication scheme, wherein the wireless communication device is to receive a control message or may be configured or pre-configured with an information containing at least one or more of
information on a frame structure of a different wireless communication system, e.g., a radio access technology, RAT, different from the WCS,
information on a frame structure and slot/subframe numbers to be used for DL based on a frame structure of the first communication scheme, e.g., which slots within the first communication scheme frame is used for DL;
information on a frame structure and slot/subframe numbers to be used for UL based on a frame structure of the first communication scheme, e.g., which slots within the first communication scheme frame is used for UL;
information on a frame structure and slot/subframe numbers to be used for DL based on a frame structure of the second communication scheme, e.g., which slots within the second communication scheme frame is used for DL;
information on a frame structure and slot/subframe numbers to be used for UL based on a frame structure of the second communication scheme, e.g., which slots within the second communication scheme frame is used for UL;
information on a timing gap being between the start/end of DL active time duration to the start/end of UL active time duration or vice versa.
Information on a timing gap between DL and UL active duration in terms of one or more of the following:
information on a timing gap being between the start/end of DL active time duration to the start/end of a next DL active time duration or vice versa;
information on a timing gap being between the start/end of UL active time duration to the start/end of a next UL active time duration or vice versa;
information on an absolute or relative position of one or more received sequences for time or frequency synchronization within a frame, super frame structure or other repeated/reoccurring time structure;
information on further absolute or relative position of one or more sequences for time or frequency synchronization within a frame, super frame structure or other repeated/reoccurring time structure which can be received in future;
information on absolute or relative position of one or more sequences for time or frequency synchronization within a frame, super frame structure or other repeated/reoccurring time structure and there scheduled repositioning.

According to a twenty-seventh aspect when referring back to any one of the first to twenty-sixth aspects, the gap is one or more of
a guard period, e.g., full-fills the purpose of allowing a deployment with the TDD frame structure of the legacy system operating in the first or second communication scheme,
adjustable, e.g., based on a configuration or pre-configuration,
divisible, e.g., the gap can be divided among one or more other gaps,
a fixed value, e.g., based on a configuration or pre-configuration.

According to a twenty-eighth aspect when referring back to the twenty-seventh aspect, the value and position of the gap depends on or is based on
a link direction, e.g., uplink or downlink transmission,
a change of link direction, e.g., a gap when switching between downlink and uplink or uplink and downlink direction,
a measurement, e.g., an interference measurement or threshold, e.g., an SINR or RSRQ or RSRP or RSSI value being above or below a configured or pre-configured value.

According to a twenty-ninth aspect when referring back to any one of the second to the twenty-eighth aspect, one or more gaps of multiple consecutive and/or neighbouring slots can be aggregated or are aggregated.

According to a thirtieth aspect when referring back to the twenty-ninth aspect, the one or more gaps may be used as one or more of
guard interval
switching gap, e.g., switching between downlink and uplink or vice versa,
for a data or control transmission
discontinuous reception, e.g., DRX-

According to a thirty-first aspect when referring back to any one of the first to thirtieth aspects,

the wireless communication device is to receive or is configured or pre-configured a control containing:
information on a frame structure of a different wireless communication system, e.g., a different radio access technology, RAT, and to operate accordingly.

According to a thirty-second aspect when referring back to any one of the first to thirty-first aspects, the wireless communication device is to receive a control or is configured or pre-configured containing at least one or more of
information on the frame and slot numbers to be used for DL based on a first communication scheme frame structure, e.g., which slots within the first communication scheme frame is used for DL;
information on the frame and slot numbers to be used for UL based on a first communication scheme frame structure, e.g., which slots within the first communication scheme frame is used for UL;
Information on the timing gap being between the start/end of DL active time duration to the start/end of UL active time duration or vice versa.
Information on a timing gap between DL and UL active duration and to operate accordingly.

According to a thirty-third aspect when referring back to any one of the first to thirty-second aspects, the wireless communication device is configured or pre-configured for obtaining timing related information comprising information identifying an absolute timing gap between DL and UL active duration, e.g., in milliseconds, ms; and to operate accordingly.

According to a thirty-fourth aspect when referring back to any one of the first to thirty-third aspects, the wireless communication device is configured for obtaining timing related information comprising information related to a timing of the second communication scheme, e.g., radioframe/slots/subframes numbering, with respect to a different wireless communication system, e.g., an Iridium system, numbering of slots/frames/Simplex slot and to operate accordingly.

According to a thirty-fifth aspect when referring back to any one of the first to thirty-fourth aspects, the first communication scheme and/or second wireless communication scheme is based on one or more of
A 3GPP wireless communication system, e.g.,
   4G-LTE, LTE or NB-IOT,
   5G-NR
   6G,
A non-3GPP wireless communication system, e.g.,
   IEEE-based such as WiFi or Bluetooth,
   Satellite-based communication, e.g., IRIDIUM or Starlink or any other Mobile Satellite Service, MSS,
   a non-terrestrial network, NTN, or NTN-IoT.

According to a thirty-sixth aspect when referring back to the thirty-fifth aspect, the wireless communication device is or comprises one of a UE and a reduced capability UE, RedCap,

According to a thirty-seventh aspect when referring back to any one of the first to thirty-sixth aspects, the first and second wireless communication scheme are based on
the same wireless communication system or
different wireless communication systems.

According to a thirty-eighth aspect when referring back to any one of the first to thirty-seventh aspects, the wireless communication device is configured for operating in a wireless communication network according to a wireless communication standard defining a frame structure comprising a plurality of slots to operate according to the first communication scheme;

wherein the wireless communication device is configured for using at least a subset of a first number of slots according to the wireless communication standard in the first communication scheme, e.g., a first operation mode; and to use at least a subset of a second number of the slots thereby deviating from the wireless communication standard in the second communication scheme, e.g., in a second operation mode.

According to a thirty-ninth aspect when referring back to any one of the first to thirty-eighth aspects, the adaptation relates to a deployment mode that includes one or more of inband, guardband, or standalone operations.

According to a fortieth aspect when referring back to any one of the first to thirty-ninth aspects, as part of the adaptation, the wireless communication device is configured to operate across different deployment modes, by using a subset of a first number of slots in the first communication scheme and deviating from the standard by using a subset of a second number of slots in the second communication scheme.

According to a forty-first aspect when referring back to any one of the first to fortieth aspects, to implement the adaptation, the wireless communication device is configured to adapt its slot usage to coexist with other wireless communication standards, such as LTE or NR-NTN, while maintaining compliance with NB-IOT standards.

According to a forty-second aspect when referring back to any one of the first to forty-first aspects, e.g., to address satellite specific challenges like propagation delay and/or synchronization delay, to implement the adaptation, the wireless communication device is configured to adjust the slot allocation and timing to account for propagation delay and/or synchronization requirements in non-terrestrial network (NTN) environments.

According to a forty-third aspect when referring back to any one of the first to forty-second aspects, to implement the adaptation the wireless communication device configured for operation in multiple frequency bands, including one or more of

Mobile satellite service, MSS, bands,

LTE bands,

NR bands,
other bands used for inband, guardband, and standalone NB-IOT deployment modes.

According to a forty-fourth aspect when referring back to any one of the first to forty-third aspects, a first number of slots used in the first communication scheme is higher when compared to the second number of slots used in the second communication scheme, e.g., the first number being 20 and the second number being 16 slots.

According to a forty-fifth aspect when referring back to any one of the first to forty-fourth aspects, the wireless communication device is configured for using a number of 20 slots according to a narrowband Internet-of-Things, NB-IOT standard and to use a number of 16 slots according to the NB-IOT standard in a different wireless communication system as the second communication scheme.

According to a forty-sixth aspect when referring back to any one of the first to forty-fifth aspects, the wireless communication device is configured for operating according to a narrowband Internet-of-Things, NB-IOT standard as the first communication scheme; and to transmit NB-IOT slots in an uplink frame of a different wireless communication system.

According to a forty-seventh aspect when referring back to any one of the first to forty-sixth aspects, the wireless communication device is configured for operating according to a narrowband Internet-of-Things, NB-IOT standard; and to receive NB-IOT slots in a downlink frame of a different wireless communication system.

According to a forty-eighth aspect when referring back to any one of the first to forty-seventh aspects, the wireless communication device is configured to optimize power consumption by selectively activating or deactivating subsets of slots as part of the adaptation.

According to a forty-ninth aspect when referring back to any one of the forty-sixth to forty-eighth aspects, the wireless communication device is configured for using slots in the second communication scheme for downlink, DL; wherein the wireless communication device is adapted to use the slots based on a DL active time duration in the first communication scheme overlapping with a DL slot in the second communication scheme frame, e.g., a satellite Communication System e.g. Iridium CS frame, although being possibly unaware of the IRIDIUM system; and/or configured for using slots in the second communication scheme or uplink, UL; wherein the wireless communication device is adapted to use the slots based on an UL active time duration in the first communication scheme overlapping an UL slot in the second communication scheme frame.

According to a fiftieth aspect when referring back to the forty-ninth aspect, a time duration of the DL slot overlapping with the DL active time duration and/or a time duration of the UL slot overlapping with the UL active time duration is linked by a respective time gap between the DL and UL active time durations, wherein the wireless communication device is configured or pre-configured with timing related information indicating the time gap; wherein the wireless communication device is to use the timing related information for the second communication scheme.

This can also be combined directly with the first aspect and the wireless communication device is configured or pre-configured with timing related information indicating a time gap between the DL and UL active time durations in the first communication scheme overlapping with a DL slot in the second communication scheme frame, the timing related information comprising at least one of:
information on a frame structure of the second communication scheme
   information identifying a time gap between consecutive UL slots
   information identifying a time gap between consecutive DL slots
   information identifying a time gap between UL and DL slot
   information identifying a time gap between DL and UL slot (includes the Simplex time slot) information identifying a simplex time slot duration
   information on the frame and slot numbers to be used for DL based on a first communication scheme frame structure, e.g., which slots within the first communication scheme frame is used for DL;
information on the frame and slot numbers to be used for UL based on a first communication scheme frame structure, e.g., which slots within the first communication scheme frame is used for UL;
information identifying an absolute timing gap between DL and UL active duration, e.g., in milliseconds, ms.
Information on the timing gap being between the start/end of DL active time duration to the start/end of UL active time duration or vice versa.
Information on a timing gap between DL and UL active duration in terms of one or more of the following
   Duration of Simplex slot
   Total duration of each UL/DL slot in a second communication scheme frame structure (including gaps) and number of UL and/or DL slots
   Any other gap duration
Information related to a timing with respect to a second communication scheme numbering of slots/frames/Simplex slot
   timing gap between DL and UL active duration in terms of the numbering, e.g., the gap is 20 slots and 1 Simplex duration
Information related to a timing with respect to a first communication scheme radioframe/slots/subframes numbering
   timing gap between DL and UL active duration in terms of the numbering, e.g., the gap is 2 radio frames/17 subframes;
   For some alignment, the gap between the DL and UL active time duration can be in terms of an integer multiple of subframes as shown in FIG. 7. E.g., here the alignment is:
   the start boundary of DL active time duration aligns with the start boundary of DL3 (excluding gap),
   the end boundary of the UL active time duration aligns with the end boundary of UL4 (excluding gap).

According to a fifty-first aspect when referring back to the fiftieth aspect, the timing related information comprises at least one of:
information on a frame structure of the second communication scheme
   information identifying a time gap between consecutive UL slots
   information identifying a time gap between consecutive DL slots
   information identifying a time gap between UL and DL slot
   information identifying a time gap between DL and UL slot (includes the Simplex time slot)
   information identifying a simplex time slot duration
information on the frame and slot numbers to be used for DL based on a first communication scheme frame structure, e.g., which slots within the first communication scheme frame is used for DL;
information on the frame and slot numbers to be used for UL based on a first communication scheme frame structure, e.g., which slots within the first communication scheme frame is used for UL;
information identifying an absolute timing gap between DL and UL active duration, e.g., in milliseconds, ms.
Information on the timing gap being between the start/end of DL active time duration to the start/end of UL active time duration or vice versa.
Information on a timing gap between DL and UL active duration in terms of one or more of the following
   Duration of Simplex slot
   Total duration of each UL/DL slot in a second communication scheme frame structure (including gaps) and number of UL and/or DL slots
   Any other gap duration
Information related to a timing with respect to a second communication scheme numbering of slots/frames/Simplex slot
   timing gap between DL and UL active duration in terms of the numbering, e.g., the gap is 20 slots and 1 Simplex duration
Information related to a timing with respect to a first communication scheme radioframe/slots/subframes numbering
   timing gap between DL and UL active duration in terms of the numbering, e.g., the gap is 2 radio frames/17 subframes;
   For some alignment, the gap between the DL and UL active time duration can be in terms of an integer multiple of subframes as shown in FIG. 7. E.g., here the alignment is:
   the start boundary of DL active time duration aligns with the start boundary of DL3 (excluding gap),
   the end boundary of the UL active time duration aligns with the end boundary of UL4 (excluding gap)

According to a fifty-second aspect when referring back to any one of the fiftieth to fifty-first aspects, the wireless communication device is configured for maintaining separate first communication scheme frame/subframe counters for UL and/or DL, e.g., to operate based on the time gap.

According to a fifty-third aspect when referring back to any one of the fiftieth to fifty-second aspects, the wireless communication device is adapted to receive information indicating an offset between the UL and DL frames, e.g., as information being in absolute time and/or a difference between time boundaries of OFDM symbols of the DL and/or UL frame counters.

According to a fifty-fourth aspect when referring back to the fifty-third aspect, the offset is such that both DL and UL active time durations are aligned to any of the DL and/or UL slots of a structure of a frame of the second communication scheme.

According to a fifty-fifth aspect when referring back to any one of the fiftieth to fifty-fourth aspects, an DL and UL active time duration is provided to the wireless communication device as subframe numbers.

According to a fifty-sixth aspect when referring back to any one of the first to fifty-fifth aspects, the wireless communication device is adapted to map a narrowband Internet-of-Things, NB-IOT frame structure to an Iridium Communication System, ICS, frame structure by using a number of NB-IOT slots having a duration not exceeding a frame duration of an Iridium Communication System, ICS, to adapt to the second communication scheme.

According to a fifty-seventh aspect when referring back to any one of the first to fifty-sixth aspects, the wireless communication device is configured for operating according to an SIB timing aligned with an Iridium timing, wherein the periodicity is an integer multiple of 90 ms, e.g., 90 ms, 180 ms, 270 ms, etc.

According to a fifty-eighth aspect when referring back to any one of the first to fifty-seventh aspects, the wireless communication device is adapted to truncate an LTE frame to an truncated LTE frame of 8 subframes consisting of a total of 16 slots, wherein each subframe has a length in time of 1 ms to adapt to the second communication scheme.

According to a fifty-ninth aspect when referring back to the fifty-eighth aspect, the wireless communication device is adapted to cut LTE NB-IOT TDD subframes that lack to carry a specific function for truncating the LTE frame.

According to a sixtieth aspect when referring back to the fifty-ninth aspect, the specific function is one or more of:
L a primary synchronization sequence, e.g., PSS or narrowband PSS, NPSS, typically transmitted in subframe 5,
a secondary synchronization sequence, e.g., SSS or narrowband SSS, NSSS, typically transmitted in subframe 9,
a broadcast channel, e.g., PBCH, or narrowband PBCH, NPBCH, typically transmitted in subframe 0,
SIB1, transmitted in subframe 4.

According to a sixty-first aspect when referring back to any one of the fifty-eighth to sixtieth aspects, the wireless communication device is adapted to include subframes 0, 4, 5, and 9 into the truncated LTE frame to adapt to the second communication scheme.

According to a sixty-second aspect when referring back to any one of the fifty-eighth to sixty-first aspects, the wireless communication device is adapted to remove 2 consecutive subframes from the LTE frame to adapt to the second communication scheme.

According to a sixty-third aspect when referring back to any one of the first to sixty-second aspects, the wireless communication device is adapted to receive or transmit the second number of slots a self-contained radioframe design for the NB-IOT LTE system as the first communication scheme to be embedded within timing constraints of an Iridium Communication System, ICS as the second communication scheme.

According to a sixty-fourth aspect when referring back to any one of the first to sixty-third aspects, the wireless communication device is configured to synchronize to a radioframe and to obtain information via signalling or to obtain information via calculation, the information indicating
A particular radioframe to be received and decoded and/or
A time instance to transmit a certain radioframe, e.g., including a pre-calculated timing advance, TA.

According to a sixty-fifth aspect when referring back to any one of the first to sixty-fourth aspects, to adapt to the second communication scheme a truncated LTE frame is fit to a radioframe having an Iridium frame structure according to an Iridium Communication System, ICS, to use the second number of slots, wherein a remaining time of the Iridium frame structure is assigned according to one of
Option A: including a half guard, e.g., 0.28 ms/2=0.14 ms at the beginning and the end of the radioframe,
Option B: adding a full guard, e.g., 0.28 ms at the end of the radioframe,
Option C: adding a full guard, e.g., 0.28 ms at the beginning of the radioframe,
Option D: adding 0.28 ms/8, e.g., 0.035 ms at the end of each subframe within the radioframe,
Option E: adding 0.28 ms/9, e.g., 0.03111 ms in between all subframes, with a total of 9 guards having the radioframe also begin and end with a guard.

According to a sixty-sixth aspect when referring back to the sixty-fifth aspect, in case of Option D or Option E, gaps after each symbol are used as cyclic prefix extension, CPE.

According to a sixty-seventh aspect when referring back to any one of the first to sixty-sixth aspects, the wireless communication device is configured for utilizing more than one Iridium slot, e.g., UL1-4 or DL1-4, of an Iridium Communication System, ICS, for transmission of a NB-IOT LTE frame.

According to a sixty-eighth aspect when referring back to any one of the first to sixty-seventh aspects, the wireless communication device is adapted to follow one or more of the following restrictions when using a second number of slots according to the second communication scheme:
Only UL slots are selected within a single frame of the second communication scheme,
Only DL slots are selected within a single frame of the second communication scheme,
Only consecutive slots are selected,
Only non-consecutive slots are selected, e.g., gaps between slots,
Between UL and DL slots selected, there is used a gap of at least a predefined number of other slots.

According to a sixty-ninth aspect when referring back to any one of the first to sixty-eighth aspects, the wireless communication device is adapted to transmit or to receive information indicating a pattern of slots of a frame of the second communication scheme used for a second number of slots according to the second communication scheme.

According to a seventieth aspect when referring back to any one of the first to sixty-ninth aspects, the wireless communication device is adapted to transmit or to receive information indicating gaps between non-consecutive slots used for a second number of slots according to the second communication scheme.

According to a seventy-first aspect when referring back to any one of the first to seventieth aspects, the wireless communication device is adapted to transmit or receive information indicating an association between UL and DL slots used in a second number of slots according to the second communication scheme; or wherein the device is to implicitly derive that in case one or more slots are allocated for a said UE in DL within a frame of the second communication scheme, providing the second number of slots, other UL slots declared for a usage according to the first communication scheme and associated with the same UE, or vice versa.

According to a seventy-second aspect when referring back to any one of the first to seventy-first aspects, the wireless communication device is adapted to operate according to a guard interval between an UL to DL slot switching of the second communication scheme, comprising excessive time of a prior first frame at an end thereof and excessive time of a subsequent second frame at a beginning thereof to combine the excessive times for the guard interval to adapt to the second communication scheme.

According to a seventy-third aspect when referring back to any one of the first to seventy-second aspects, the wireless communication device is adapted to map a same message to all or a subset of a first number of slots of the first communication scheme and to all or the subset of a second number of slots of the second communication scheme.

A seventy-fourth aspect relates to a method for performing wireless communication, the method comprising: using at least a subset of a first number of slots according to a wireless communication scheme according to a first communication scheme, e.g., a first operation mode; and using at least a subset of a second number of the slots thereby deviating from the wireless communication scheme to operate according to a second communication scheme, e.g., in a second operation mode.

A seventy-fifth aspect relates to a method for performing wireless communication, the method comprising: transmitting a wireless signal comprising a slot structure according to a first communication scheme, e.g. a first standard using a second communication scheme uplink frame; e.g., the devices/infrastructure, frequencies or bands; and/or receiving a wireless signal comprising a slot structure according to a first communication scheme standard via a second communication scheme downlink frame; e.g., the devices/infrastructure, frequencies or bands.

A seventy-sixth aspect relates to a wireless signal being obtained by a method when referring back to the seventy-fourth or seventy-fifth aspect.

A seventy-seventh aspect relates to a non-transitory storage medium having stored thereon information representing the wireless signal when referring back to the seventy-sixth aspect.

A seventy-eighth aspect relates to a computer readable digital storage medium having stored thereon a computer program having a program code for performing, when running on a computer, a method when referring back to the seventy-fourth or seventy-fifth aspect.

According to a seventy-ninth aspect when referring back to any one of the first to seventy-eighth aspects, a wireless communication device is configured for processing a signal transmitted occupying at least one slot/subframe that is according to a first wireless communication scheme or standard, the at least one slot/subframe optionally being included in a frame structure according to a different second wireless communication scheme or standard.

An eightieth aspect relates to a wireless communication device configured for operating according to a wireless communication scheme/standard defining a first frame structure comprising a plurality of slots having a slot structure; receiving a signal indicating to use the slot structure in a second frame structure of a different communication scheme/standard; and to operate accordingly.

An eighty-first aspect relates to a user device for a wireless communication system, WCS, wherein the user device is to receive a control message or may be configured or pre-configured with an information containing at least one or more of
information on a frame structure of a different wireless communication system, e.g., a radio access technology, RAT, different from the WCS
information on a frame structure and slot/subframe numbers to be used for DL based on a frame structure of the first communication scheme, e.g., which slots within the first communication scheme frame is used for DL;
information on a frame structure and slot/subframe numbers to be used for UL based on a frame structure of the first communication scheme, e.g., which slots within the first communication scheme frame is used for UL;
information on a frame structure and slot/subframe numbers to be used for DL based on a frame structure of the second communication scheme, e.g., which slots within the second communication scheme frame is used for DL;
information on a frame structure and slot/subframe numbers to be used for UL based on a frame structure of the second communication scheme, e.g., which slots within the second communication scheme frame is used for UL;
Information on a timing gap being between the start/end of DL active time duration to the start/end of UL active time duration or vice versa.
Information on a timing gap between DL and UL active duration in terms of one or more of the following.
Information on a timing gap being between the start/end of DL active time duration to the start/end of a next DL active time duration or vice versa.
Information on a timing gap being between the start/end of UL active time duration to the start/end of a next UL active time duration or vice versa.
Information on an absolute or relative position of one or more received sequences for time or frequency synchronization within a frame, super frame structure or other repeated/reoccurring time structure.
Information on further absolute or relative position of one or more sequences for time or frequency synchronization within a frame, super frame structure or other repeated/reoccurring time structure which can be received in future.
Information on absolute or relative position of one or more sequences for time or frequency synchronization within a frame, super frame structure or other repeated/reoccurring time structure and there scheduled repositioning.

An eighty-second aspect relates to a user device of a wireless communication system,

wherein the user device is to receive a control message containing
information on a frame structure of a different wireless communication system, e.g., a different radio access technology, RAT,

wherein the user device is to receive a control message or may be configured or pre-configured with an information containing at least one or more of
information on the frame and slot numbers to be used for DL based on the first communication scheme frame structure, e.g., which slots within the first communication scheme frame is used for DL;
information on the frame and slot numbers to be used for UL based on the first communication scheme frame structure, e.g., which slots within the first communication scheme frame is used for UL;
Information on the timing gap being between the start/end of DL active time duration to the start/end of UL active time duration or vice versa.
Information on a timing gap between DL and UL active duration in terms of one or more of the following.

An eighty-third aspect relates to a wireless communication device, e.g., a base station, adapted for providing a control message containing at least one or more of
information on a frame structure of a different wireless communication system, e.g., a radio access technology, RAT, different from the WCS
information on a frame structure and slot/subframe numbers to be used for DL based on a frame structure of the first communication scheme, e.g., which slots within the first communication scheme frame is used for DL;
information on a frame structure and slot/subframe numbers to be used for UL based on a frame structure of the first communication scheme, e.g., which slots within the first communication scheme frame is used for UL;
information on a frame structure and slot/subframe numbers to be used for DL based on a frame structure of the second communication scheme, e.g., which slots within the second communication scheme frame is used for DL;
information on a frame structure and slot/subframe numbers to be used for UL based on a frame structure of the second communication scheme, e.g., which slots within the second communication scheme frame is used for UL;
Information on a timing gap being between the start/end of DL active time duration to the start/end of UL active time duration or vice versa.
Information on a timing gap between DL and UL active duration in terms of one or more of the following:
Information on a timing gap being between the start/end of DL active time duration to the start/end of a next DL active time duration or vice versa;
Information on a timing gap being between the start/end of UL active time duration to the start/end of a next UL active time duration or vice versa;
Information on an absolute or relative position of one or more received sequences for time or frequency synchronization within a frame, super frame structure or other repeated/reoccurring time structure;
Information on further absolute or relative position of one or more sequences for time or frequency synchronization within a frame, super frame structure or other repeated/reoccurring time structure which can be received in future;
Information on absolute or relative position of one or more sequences for time or frequency synchronization within a frame, super frame structure or other repeated/reoccurring time structure and there scheduled repositioning.

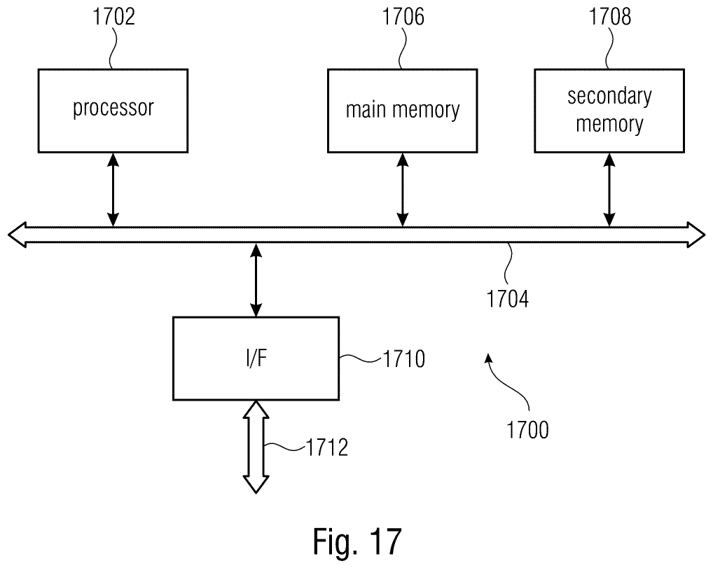

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 17 illustrates an example of a computer system 1700. The units or modules as well as the steps of the methods performed by these units may execute on one or more computer systems 1700. The computer system 1700 includes one or more processors 1702, like a special purpose or a general-purpose digital signal processor. The processor 1702 is connected to a communication infrastructure 1704, like a bus or a network. The computer system 1700 includes a main memory 1706, e.g., a random-access memory (RAM), and a secondary memory 1708, e.g., a hard disk drive and/or a removable storage drive. The secondary memory 1708 may allow computer programs or other instructions to be loaded into the computer system 1700. The computer system 1700 may further include a communications interface 1710 to allow software and data to be transferred between computer system 1700 and external devices. The communication may be in the form of electronic, electromagnetic, optical, or other signals capable of being handled by a communications interface. The communication may use a wire or a cable, fibre optics, a phone line, a cellular phone link, an RF link and other communications channels 1712.

The terms “computer program medium” and “computer readable medium” are used to generally refer to tangible storage media such as removable storage units or a hard disk installed in a hard disk drive. These computer program products are means for providing software to the computer system 1700. The computer programs, also referred to as computer control logic, are stored in main memory 1706 and/or secondary memory 1708. Computer programs may also be received via the communications interface 1710. The computer program, when executed, enables the computer system 1700 to implement the present invention. In particular, the computer program, when executed, enables processor 1702 to implement the processes of the present invention, such as any of the methods described herein. Accordingly, such a computer program may represent a controller of the computer system 1700. Where the disclosure is implemented using software, the software may be stored in a computer program product and loaded into computer system 1700 using a removable storage drive, an interface, like communications interface 1710.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

| Abbreviation | Definition | Further description |
|---|---|---|
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AFOV | angular field of view | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received | |
| CP | control plane | |
| CP1 | control plane 1 | |
| CP2 | control plane 2 | |
| CPRI | common public radio interface | |
| CSI-IM | channel state information | |
| CSI-RS | channel state information reference | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell galobal identifier | |
| E-CID | enhanced cell ID | |
| eCPRI | enhanced CPRI | |
| EFOV | effective field-of-view | |
| eNB | evolved Node b | |
| EN-DC | e-UTRAN-New Radio dual | |
| EUTRA | enhanced UTRA | |
| E-UTRAN | enhanced UTRA network | |
| FOV | field-of-view | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity/identification | |
| IF | intermediate frequency | |
| IIOT | industrial internet of things | |
| KPI | key-performance indicator | |
| LEO | low Earth-orbit | associated with |
| | | satellites |
| LOS | line-of-sight | |
| LTE | long-term evolution | |
| MCG | master cell group | |
| MCS | modulation coding scheme | |
| MDT | minimization of drive tests | |
| MIMO | multiple-input/multiple-output | |
| MLR | measure log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA |
| NG-RAN | either a gNB or an NG-eNB | |
| NGSO | non-geostationary orbit | |
| NIC | network interface connection | |
| NLOS | non line-of-sight | |
| NR | new radio | |
| NR-U | NR unlicensed | NR operating |
| | | in [symbol] |
| NTN | non-terrestrial network | |
| OAM | operation and maintenance | |
| OEM | original equipment manufacturer | |
| OTT | over-the-top | |
| oRAN | see open RAN | |
| Open RAN | open radio access network | |
| PCI | physical cell identifier | Also known as |
| | | PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RE | resource element | |
| RF | radio frequency | |
| RIM | radio access network information | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIB | system information block | |
| SINR | signal-to-interference-plus-noise | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | sounding reference indication | |
| SS | synchronization signal | |
| SSB | synchronization signal block | |
| SSID | service set identifier | |
| SS-PBCH | sounding signal/physical broadcast | |
| TAC | tracking area code | |
| TB | transmission block | |
| TCI | transmission configuration indication | |
| TDD | time division duplex | |
| TN | terrestrial network | |
| TSG | technical specification group | |
| UAV | unmanned airborne vehicle | |
| UE | user equipment | |
| UL | uplink | |
| UP | user plane | |
| URLLC | ultra-reliable low latency | |
| UTRAN | universal trunked radio access | |
| V2X | vehicle-to-everything | |
| VoIP | voice over internet protocol | |
| vRAN | virtual ran | |
| WI | work item | |
| WLAN | wireless local area network | |

[symbol]

indicates data missing or illegible when filed

1. A wireless communication device, e.g., a user device, configured for processing [TX/RX] a signal transmitted occupying at least one slot/subframe/radioframe that is according to a second wireless communication scheme;
wherein the signal is an adaptation of a first communication scheme to fit the second communication scheme.

2. The wireless communication device according to claim 1, wherein the adaptation comprises one or more of:
a change in a number of slots/subframes from the first wireless communication scheme, e.g., from a number of 10 slots/subframes to a number of 8 slots/subframes;
an addition of a gap between two slots/subframes of the first communication scheme and/or at the beginning and/or end of the at least one slot/subframe,
an addition of a synchronization structure to the at least one slot/subframe,
an offset or shift, e.g., a time shift, of the first slot of the one or more slots.

3. The wireless communication device of claim 1, wherein the device is adapted to adapt the signal to fit the second communication scheme based on receiving a channel such as a broadcast channel in accordance with the second communication scheme.

4. The wireless communication device of claim 1, wherein the device is adapted to process the signal in accordance with the first communication scheme based on receiving a channel such as a broadcast channel in accordance with the first communication scheme.

5. The wireless communication device of claim 1, wherein the device is to adapt to process the signal in accordance with a first or second communication scheme based on a pre-configuration and/or device capability, e.g., based on a device category or device capability information exchanged with a base station.

6. The wireless communication device of claim 1, wherein the device is adapted to assume signals to be transmitted, e.g., by a base station, in a subset of subframes of a radio frame, e.g., according to a frame structure type 1, namely in the downlink subframes 3, 4, 5, 6, 7, 8, 9, 0.

7. The wireless communication device of claim 1, wherein the device is adapted to transmit in a subset of subframes of a radio frame, namely in 8 consecutive uplink subframes, e.g., subframes 1, 2, 3, 4, 5, 6, 7, 8.

8. The wireless communication device of claim 1, wherein the device is adapted to not transmit on any subframe other than the 8 consecutive uplink subframes, e.g., subframes 1, 2, 3, 4, 5, 6, 7, 8.

9. The wireless communication device of claim 1, wherein the device is configured with 50 consecutive guard period subframes following the 8 downlink subframes.

10. The wireless communication device of claim 1, wherein the device is configured with 24 consecutive guard period subframes following the 8 uplink subframes, e.g., in each 90 ms interval.

11. The wireless communication device of claim 1, adapted to transmit or receive a message, e.g., in a System Information Block, SIB, referring to a synchronization reference anchor allowing to determine the location of the SIB received relative to an overall frame structure.

12. The wireless communication device of claim 1, wherein
the slots/subframe/radioframe comprises an anchor carrier comprising one or more of
a broadcast information, e.g., MIB or SIB or SIB1, transmitted via BCH,
a synchronization signal, e.g., PSS or SSS,
control,
data.

13. The wireless communication device of claim 1, wherein
the slots/subframe/radioframe comprises an non-anchor carrier comprising one or more of
a broadcast information, e.g., MIB or SIB or SIB1, transmitted via BCH,
a synchronization signal, e.g., PSS or SSS,
control,
data.

14. The wireless communication device of claim 11, adapted to transmit or receive the message in one or more slots of one or more frames inside a superframe or hyperframe structure.

15. The wireless communication device according to claim 1, configured for operating according to a wireless communication scheme/standard as the first communication scheme and defining a first frame structure comprising a plurality of slots having a slot structure;
receiving a signal indicating or configuring or pre-configuring to use the slot structure in a second frame structure of a different communication scheme/standard as the second communication scheme; and
to operate accordingly.

16. The wireless communication device according to claim 1, wherein the gap is one or more of
a guard period, e.g., full-fills the purpose of allowing a deployment with the TDD frame structure of the legacy system operating in the first or second communication scheme,
adjustable, e.g., based on a configuration or pre-configuration,
divisible, e.g., the gap can be divided among one or more other gaps,
a fixed value, e.g., based on a configuration or pre-configuration.

17. The wireless communication device according to claim 16, wherein the value and position of the gap depends on or is based on
a link direction, e.g., uplink or downlink transmission,
a change of link direction, e.g., a gap when switching between downlink and uplink or uplink and downlink direction,
a measurement, e.g., an interference measurement or threshold, e.g., an SINR or RSRQ or RSRP or RSSI value being above or below a configured or pre-configured value.

18. The wireless communication device of claim 1, wherein the first communication scheme and/or second wireless communication scheme is based on one or more of
A 3GPP wireless communication system, e.g.,
4G-LTE, LTE or NB-IOT,
5G-NR
6G,
A non-3GPP wireless communication system, e.g.,
IEEE-based such as WiFi or Bluetooth,
Satellite-based communication, e.g., IRIDIUM or Starlink or any other Mobile Satellite Service, MSS,
a non-terrestrial network, NTN, or NTN-IoT.

19. The wireless communication device of claim 18, being or comprising one of a UE and a reduced capability UE, RedCap,

20. The wireless communication device according to claim 1, wherein a first number of slots used in the first communication scheme is higher when compared to the second number of slots used in the second communication scheme, e.g., the first number being 20 and the second number being 16 slots.

21. The wireless communication device according to claim 1, configured for using a number of 20 slots according to a narrowband Internet-of-Things, NB-IOT standard and to use a number of 16 slots according to the NB-IOT standard in a different wireless communication system as the second communication scheme.

22. The wireless communication device according to claim 1, configured for operating according to a narrowband Internet-of-Things, NB-IOT standard as the first communication scheme; and
5 to transmit NB-IOT slots in an uplink frame of a different wireless communication system.

23. The wireless communication device according to claim 1, configured for operating according to a narrowband Internet-of-Things, NB-IOT standard; and
to receive NB-IOT slots in a downlink frame of a different wireless communication system.

24. The wireless communication device according to claim 1, is configured or pre-configured with timing related information indicating a time gap between the DL and UL active time durations in the first communication scheme overlapping with a DL slot in the second communication scheme frame, the timing related information comprising at least one of:
information on a frame structure of the second communication scheme
information identifying a time gap between consecutive UL slots
information identifying a time gap between consecutive DL slots
information identifying a time gap between UL and DL slot
information identifying a time gap between DL and UL slot (comprises the Simplex time slot)
information identifying a simplex time slot duration
information on the frame and slot numbers to be used for DL based on a first communication scheme frame structure, e.g., which slots within the first communication scheme frame is used for DL;
information on the frame and slot numbers to be used for UL based on a first communication scheme frame structure, e.g., which slots within the first communication scheme frame is used for UL;
information identifying an absolute timing gap between DL and UL active duration, e.g., in milliseconds, ms.
Information on the timing gap being between the start/end of DL active time duration to the start/end of UL active time duration or vice versa,
Information on a timing gap between DL and UL active duration in terms of one or more of the following
Duration of Simplex slot
Total duration of each UL/DL slot in a second communication scheme frame structure (comprising gaps) and number of UL and/or DL slots
Any other gap duration
Information related to a timing with respect to a second communication scheme numbering of slots/frames/Simplex slot
timing gap between DL and UL active duration in terms of the numbering, e.g., the gap is 20 slots and 1 Simplex duration
Information related to a timing with respect to a first communication scheme radioframe/slots/subframes numbering
timing gap between DL and UL active duration in terms of the numbering, e.g., the gap is 2 radio frames/17 subframes;
For some alignment, the gap between the DL and UL active time duration can be in terms of an integer multiple of subframes as shown in FIG. 7. E.g., here the alignment is:
the start boundary of DL active time duration aligns with the start boundary of DL3 (excluding gap),
the end boundary of the UL active time duration aligns with the end boundary of UL4 (excluding gap)

25. The wireless communication device according to claim 1, adapted to truncate an LTE frame to an truncated LTE frame of 8 subframes comprising a total of 16 slots, wherein each subframe has a length in time of 1 ms to adapt to the second communication scheme.

26. The wireless communication device according to claim 25, adapted to cut LTE NB-IOT TDD subframes that lack to carry a specific function for truncating the LTE frame.

27. The wireless communication device according to claim 1, adapted to follow one or more of the following restrictions when using a second number of slots according to the second communication scheme:
Only UL slots are selected within a single frame of the second communication scheme,
Only DL slots are selected within a single frame of the second communication scheme,
Only consecutive slots are selected,
Only non-consecutive slots are selected, e.g., gaps between slots,
Between UL and DL slots selected, there is used a gap of at least a predefined number of other slots.

28. A wireless communication device configured for operating according to a wireless communication scheme/standard defining a first frame structure comprising a plurality of slots having a slot structure;
receiving a signal indicating to use the slot structure in a second frame structure of a different communication scheme/standard; and
to operate accordingly.

29. A user device of a wireless communication system,
wherein the user device is to receive a control message comprising
information on a frame structure of a different wireless communication system, e.g., a different radio access technology, RAT,
wherein the user device is to receive a control message or may be configured or pre-configured with an information comprising at least one or more of
information on the frame and slot numbers to be used for DL based on the first communication scheme frame structure, e.g., which slots within the first communication scheme frame is used for DL;
information on the frame and slot numbers to be used for UL based on the first communication scheme frame structure, e.g., which slots within the first communication scheme frame is used for UL;
Information on the timing gap being between the start/end of DL active time duration to the start/end of UL active time duration or vice versa.
Information on a timing gap between DL and UL active duration in terms of one or more of the following.

30. A wireless communication device, e.g., a base station, adapted for providing a control message comprising at least one or more of
information on a frame structure of a different wireless communication system, e.g., a radio access technology, RAT, different from the WCS
information on a frame structure and slot/subframe numbers to be used for DL based on a frame structure of the first communication scheme, e.g., which slots within the first communication scheme frame is used for DL;
information on a frame structure and slot/subframe numbers to be used for UL based on a frame structure of the first communication scheme, e.g., which slots within the first communication scheme frame is used for UL;
information on a frame structure and slot/subframe numbers to be used for DL based on a frame structure of the second communication scheme, e.g., which slots within the second communication scheme frame is used for DL;
information on a frame structure and slot/subframe numbers to be used for UL based on a frame structure of the second communication scheme, e.g., which slots within the second communication scheme frame is used for UL;
Information on a timing gap being between the start/end of DL active time duration to the start/end of UL active time duration or vice versa;
Information on a timing gap between DL and UL active duration in terms of one or more of the following:
Information on a timing gap being between the start/end of DL active time duration to the start/end of a next DL active time duration or vice versa;
Information on a timing gap being between the start/end of UL active time duration to the start/end of a next UL active time duration or vice versa;
Information on an absolute or relative position of one or more received sequences for time or frequency synchronization within a frame, super frame structure or other repeated/reoccurring time structure;
Information on further absolute or relative position of one or more sequences for time or frequency synchronization within a frame, super frame structure or other repeated/reoccurring time structure which can be received in future;
Information on absolute or relative position of one or more sequences for time or frequency synchronization within a frame, super frame structure or other repeated/reoccurring time structure and there scheduled repositioning.
